(19) United States
(12) Patent Application Publication
(10) Pub. No.: US 2023/0395270 A1
(43) Pub. Date: Dec. 7, 2023

(54) POOL TYPE LIQUID METAL COOLED MOLTEN SALT REACTOR

(71) Applicant: Alpha Tech Research Corp., Salt Lake City, UT (US)

(72) Inventors: John Benson, Pleasant Grove, UT (US); Matthew Memmott, Provo, UT (US)

(21) Appl. No.: 18/341,760

(22) Filed: Jun. 27, 2023

Related U.S. Application Data
(63) Continuation of application No. PCT/US20/67758, filed on Dec. 31, 2020.

(51) Int. Cl. G21C 9/02; G21C 9/027; G21C 1/03; G21C 7/12

(52) U.S. Cl. CPC G21C 9/022; G21C 9/027; G21C 1/03; G21C 7/12; G21C 7/24

(57) ABSTRACT

A molten salt reactor is disclosed. In some embodiments, the molten salt reactor comprises a containment vessel; a molten salt chamber disposed within the containment vessel; a molten salt mixture disposed within the molten salt chamber; and a heat exchange system at least partially disposed within the molten salt chamber. In some embodiments, the molten salt reactor comprises one or more of a shutdown mechanism, a thermally activated failsafe mechanism, and/or a passive reactivity control system. The shutdown mechanism, for example, may be coupled with the molten salt chamber, the shutdown mechanism comprising a material that when inserted into the molten salt chamber will inhibit fission reactions within the molten salt mixture. The thermally activated failsafe mechanism, for example, may be coupled with the molten salt chamber, the thermally activated failsafe mechanism passively inhibits fission reactions within the molten salt mixture.

### BACKGROUND

Molten salt reactors are a class of nuclear fission reactors in which the primary nuclear reactor coolant and/or the fuel is a molten salt mixture. In a typical design, a molten salt is pumped between a critical core and an external heat exchanger where the heat is transferred to a nonradioactive secondary salt. The secondary salt then transfers its heat to a steam turbine or closed-cycle gas turbine.

Molten salt fueled reactors incorporate nuclear fuel, typically in the form of uranium tetrafluoride into a carrier salt (e.g. FLiBe, FLiNaK). Fluoride-salt-cooled high temperature reactors (FHR), on the other hand, utilize solid fuel like TRISO with a molten salt coolant. Molten salt reactors may include both burners and breeders in fast or thermal spectra, using fluoride or chloride salt-based fuels and a range of fissile or fertile consumables.

Molten salt reactors offer multiple advantages over conventional nuclear power plants and there are many advantages for improvements to molten salt reactors that allow for safer or more efficient operations.

### SUMMARY

A molten salt reactor is disclosed. In some embodiments, the molten salt reactor comprises a containment vessel; a molten salt chamber disposed within the containment vessel; a molten salt mixture disposed within the molten salt chamber; and a heat exchange system at least partially disposed within the molten salt chamber. In some embodiments, the molten salt reactor comprises one or more of a shutdown mechanism, a thermally activated failsafe mechanism, and/or a passive reactivity control system. The shutdown mechanism, for example, may be coupled with the molten salt chamber, the shutdown mechanism comprising a material that when inserted into the molten salt chamber will inhibit fission reactions within the molten salt mixture. The thermally activated failsafe mechanism, for example, may be coupled with the molten salt chamber, the thermally activated failsafe mechanism, for example, may passively inhibit fission reactions within the molten salt mixture.

Some embodiments include a molten salt reactor comprising: a containment vessel; a molten salt chamber disposed within the containment vessel; a molten salt mixture disposed within the molten salt chamber; a heat exchange system at least partially disposed within the molten salt chamber; a shutdown mechanism coupled with the molten salt chamber, the shutdown mechanism comprising a material that when inserted into the molten salt chamber will inhibit fission reactions within the molten salt mixture; a thermally activated failsafe mechanism coupled with the molten salt chamber, thermally activated failsafe mechanism passively inhibits fission reactions within the molten salt mixture; and a passive reactivity control system.

In some embodiments, the shutdown mechanism is inserted into a high neutron flux region of the molten salt chamber to inhibit fission reactions within the molten salt mixture.

In some embodiments, the containment vessel comprises a material with an ASME code case. In some embodiments, the containment vessel comprises one or more materials selected from the list consisting of molybdenum, tungsten, TZM, stainless steel 316, a nickel-based alloy like Inconel or Hastelloy-N, and silicon carbide. In some embodiments, the containment vessel has an external coating that prevents volatilization and/or oxidation at high temperatures.

In some embodiments, the external coating comprises one or more materials selected from the list consisting of copper and aluminum

In some embodiments, the containment vessel comprises molybdenum or tungsten. In some embodiments, the containment vessel comprises molybdenum with a copper coating.

In some embodiments, the molten salt chamber comprises a material that substantially resists corrosion from contact with the molten salt mixture. In some embodiments, the molten salt chamber comprises molybdenum or silicon carbide. In some embodiments, the molten salt chamber comprises reactor-grade graphite.

In some embodiments, the molten salt chamber comprises a coating to assist in resisting corrosion from contact with the molten salt mixture. In some embodiments, the molten salt chamber comprises a diamond embedded molten salt chamber wall.

In some embodiments, the containment vessel and the molten salt chamber are the same vessel.

In some embodiments, the molten salt mixture comprises a fluoride salt. In some embodiments, the molten salt mixture comprises one or more salts selected from the group consisting of: NaF, MgF2, KF, ThF4, BeF2, LiF, CaF2, and UF4. In some embodiments, the molten salt mixture comprises one or more salts selected from the group consisting of: NaF, MgF2, KF, CaF2, ThF4, and UF4. In some embodiments, the molten salt mixture comprises one or more salts selected from the group consisting of: NaF, MgF2, KF, ThF4, and UF4. In some embodiments, the molten salt mixture comprises a neutron moderator.

In some embodiments, the molten salt mixture comprises diamond particulates. In some embodiments, the molten salt mixture comprises neutron moderating particulates that are substantially the same size. In some embodiments, the molten salt mixture comprises a packed bed of neutron moderating particulates. In some embodiments, the packed bed of neutron moderating particulates comprises particulates of substantially the same size. In some embodiments, the packed bed of neutron moderating particulates has a high packing fraction. In some embodiments, the packed bed of neutron moderating particulates comprises three or more discrete sizes of neutron moderating particulates. In some embodiments, the packed bed of neutron moderating particulates comprises particulates of roughly two different sizes. In some embodiments, the packed bed of neutron moderating particulates comprises particulates of 35/40 mesh. In some embodiments, the packed bed of neutron moderating particulates comprises particulates of 230/270 mesh. In some embodiments, the packed bed of neutron moderating particulates comprises particulates of 600 mesh.

In some embodiments, a molten salt chamber may include a burnable poison that decreases the reactivity of the molten salt. In some embodiments, the burnable poison comprises samarium fluoride, gadolinium fluoride, and/or boron carbide. In some embodiments, the burnable poison is disposed within the molten salt mixture. In some embodiments, the burnable poison is disposed within one or more structure disposed throughout the molten salt chamber.

In some embodiments, the one or more structures comprise silicon carbide.

In some embodiments, the molten salt chamber comprises one or more neutron moderating structures disposed within the molten salt chamber. In some embodiments, the one or moderating structures comprise one or more stacked plates composed of moderator materials. In some embodiments, the one or more moderating structures form a prism-like pattern. In some embodiments, the one or more moderating structures comprise graphite, silicon carbide, diamond, and/or molybdenum.

In some embodiments, the one or more moderating structures comprise diamond disposed within a shell of silicon carbide, graphite, or molybdenum. In some embodiments, the diamond particles are disposed within the neutron moderating structures.

In some embodiments, the one or more moderating structures comprise a material including diamond and a binder material. In some embodiments, the binder material comprises silicon carbide, molybdenum, and/or graphite. In some embodiments, the one or more moderating structures comprise diamond and a liquid metal disposed within a shell.

In some embodiments, the one or more moderating structures comprise a salt mixture disposed within one or more shells with a liquid metal coolant surrounding the shell. In some embodiments, the one or more shells comprise molybdenum, silicon carbide, or graphite.

In some embodiments, a molten salt chamber includes one or more irradiation chambers that produce isotopes.

In some embodiments, a molten salt chamber includes a breeding blanket at least partially surrounding the molten fuel mixture.

In some embodiments, the heat exchange system is disposed at least partially within the molten salt chamber. In some embodiments, the heat exchange system is integrated into the containment vessel. In some embodiments, the heat exchanger comprises heat exchange tubes that extend into the molten salt chamber. In some embodiments, the heat exchanger tubes are made of molybdenum. In some embodiments, the heat exchanger tubes are shaped in a U-bend formation.

In some embodiments, the heat exchanger tubes comprise concentric tubes. In some embodiments, the heat exchanger tubes are attached at the top and bottom of the molten salt chamber. In some embodiments, the heat exchanger system comprises an ASME code case material.

In some embodiments, a coolant is flowed through the heat exchanger tubes. In some embodiments, the coolant comprises at least one material selected from the list comprising lead, magnesium-aluminum, aluminum, silicone-aluminum, and tin. In some embodiments, the coolant comprises a liquid metal.

In some embodiments, a neutron poison is added to the coolant to inhibit a fissile reaction within the molten salt mixture.

In some embodiments, a molten salt reactor includes a reflector have a first state and a second state, in the first state the reflector is surrounding the molten salt chamber and in the second state the reflector is moved to surround less of the molten salt chamber.

In some embodiments, the shutdown mechanism comprises a thermally and/or magnetically (or electromagnetically) activated door that separates a plurality of shutdown spheres from the molten salt chamber.

In some embodiments a molten salt reactor includes one or more shutdown sphere channels disposed within the molten salt chamber and connected with the door.

In some embodiments a molten salt reactor includes a shutdown liquid that can flow the shutdown spheres into and out of the shutdown sphere channel.

In some embodiments a molten salt reactor includes one or more magnets that move the plurality of shutdown spheres into and through the shutdown channels. In some embodiments, the plurality of shutdown spheres are interconnected with a wire. In some embodiments, the plurality of shutdown spheres are disposed within a funnel connected with the door and disposed outside the molten salt chamber. In some embodiments, the shutdown spheres are disposed in a helix formation outside the molten salt chamber during reactor operation.

In some embodiments, the shutdown mechanism comprises one or more shutdown sphere channels that extends into the molten salt chamber and a shutdown sphere containment vessel disposed outside the molten salt chamber, a plurality of shutdown spheres are disposed within the shutdown sphere containment vessel. In some embodiments, the shutdown spheres channels comprise silicon carbide or molybdenum. In some embodiments, the shutdown spheres comprise one more materials selected from the list comprising boron, samarium, cadmium, boron carbide, tungsten carbide, silver, tungsten, samarium carbide, and gadolinium. In some embodiments, the shutdown mechanism comprises one or more shutdown rods that is actuated into and out of the molten salt chamber via one or more shutdown rod channel.

In some embodiments, the one or more shutdown rod channels comprises silicon carbide and/or molybdenum. In some embodiments, the one or more shutdown rods comprise one or more of boron, samarium, cadmium, boron carbide, tungsten carbide, silver, tungsten, samarium, and/or gadolinium.

In some embodiments, the shutdown mechanism comprises a liquid metal neutron poison that has a high absorption cross section and a low melting point when combined with a coolant. In some embodiments, the liquid metal neutron poison is miscible with the coolant. In some embodiments, the liquid metal neutron poison comprises indium. In some embodiments, the liquid metal neutron poison comprises an indium-lead alloy. In some embodiments, the liquid metal neutron poison is immiscible with the coolant.

In some embodiments, thermally activated failsafe comprises a neutron poison chamber coupled with the molten salt chamber, and the molten salt reactor comprises a neutron poison disposed within the neutron poison chamber and a thermally activated door is disposed between the molten salt chamber and the neutron poison chamber such that thermally activated door is closed when the temperature is below a critical safety temperature and opened when the temperature is above the critical safety temperature. In some embodiments, the neutron poison comprises a plurality of small spheres. In some embodiments, the critical safety temperature is above about 1,000 C and below about 1,300 C.

In some embodiments, thermally activated failsafe comprises a neutron poison having a melting point about at the critical safety temperature and disposed relative to the molten salt chamber such that when the critical safety temperature is exceeded, the neutron poison melts and flows into the molten salt chamber.

In some embodiments, thermally activated failsafe comprises: a neutron poison container disposed outside the molten salt chamber; a neutron poison channel that extends into the molten salt chamber and in communication with the neutron poison container, the neutron poison channel extends into the molten salt chamber; and a neutron poison disposed in the neutron poison container and having a melting point at about the critical safety temperature of the molten salt reactor.

In some embodiments a molten salt reactor includes a perforated separator having a plurality of perforations, the perforated separator disposed within the molten salt chamber.

In some embodiments a molten salt reactor includes a neutron reflecting material surrounding the molten salt chamber.

In some embodiments a molten salt reactor includes a packed bed of moderating materials surrounding the molten salt chamber.

In some embodiments a molten salt reactor includes a heavy element melted into the packed bed of moderating materials. In some embodiments, the heavy element comprises lead and the packed bed of moderating materials comprises a packed bed of diamond particulates.

Some embodiments include a molten salt reactor comprising: a containment vessel; a molten salt chamber disposed within the containment vessel; a molten salt mixture disposed within the molten salt chamber; a heat exchange system at least partially disposed within the molten salt chamber; and a shutdown mechanism coupled with the molten salt chamber, the shutdown mechanism comprising a material that when inserted into the molten salt chamber will inhibit fission reactions within the molten salt mixture.

Some embodiments include a molten salt reactor comprising: a containment vessel; a molten salt chamber disposed within the containment vessel; a molten salt mixture disposed within the molten salt chamber; a heat exchange system at least partially disposed within the molten salt chamber; and a thermally activated failsafe mechanism coupled with the molten salt chamber, thermally activated failsafe mechanism passively inhibits fission reactions within the molten salt mixture.

Some embodiments include a molten salt reactor comprising: a containment vessel; a molten salt chamber disposed within the containment vessel; a molten salt mixture disposed within the molten salt chamber; a heat exchange system at least partially disposed within the molten salt chamber; and a passive reactivity control system.

Some embodiments include a molten salt reactor comprising: a molten salt chamber; a molten salt mixture disposed within the molten salt chamber; a neutron poison chamber coupled with or disposed within the molten salt chamber and having a cavity that is in communication with the molten salt chamber; a neutron poison disposed within the cavity of the neutron poison chamber; and a thermal safety failsafe disposed between and separating the neutron poison and the molten salt chamber, the molten salt poison having a melting point at or above a critical safety temperature of the molten salt mixture, thermal safety failsafe disposed relative to thermal safety failsafe such that when thermal safety failsafe melts, the neutron poison flows from the neutron poison chamber into the molten salt chamber.

In some embodiments, the neutron poison comprises samarium. In some embodiments, the neutron poison comprises boron, boron carbide, indium, or gadolinium. In some embodiments, the neutron poison comprises a plurality of spheres.

In some embodiments, thermal safety failsafe has a melting point between about 1,000° C.-1,300° C. In some embodiments, a molten salt reactor comprises a heat exchanger manifold, and thermal safety failsafe and the neutron poison are disposed within or coupled with the exchanger manifold. In some embodiments, thermal safety failsafe comprises solder that melts at the critical safety temperature of the molten salt eutectic.

In some embodiments, a molten salt reactor comprises a shutdown rod channel that extends into the molten salt chamber; and a shutdown rod comprising a neutron dampening material disposed relative to the shutdown rod channel such that the shutdown rod can be moved into and out of the shutdown rod channel.

In some embodiments, a molten salt reactor comprises a magnet (or electromagnet) coupled with the shutdown rod, the magnet holding the shutdown rod in a position where the shutdown rod does not extend into the molten salt chamber, the magnet having a curie temperature that is at or below the critical safety temperature of the molten salt mixture or molten salt chamber such that when the temperature of the magnet is at or near the critical safety temperature, the magnetic field of the magnet is weakened sufficiently to allow the shutdown rod to move into the shutdown rod channel. The magnet may be selected to ensure the curie temperature is less than the critical safety temperature of the molten salt mixture and/or the molten salt chamber. The magnet may have a curie temperature and/or configuration relative to the critical safety temperature such that the magnet may release at or near the critical safety temperature.

In some embodiments, the shutdown rod comprises boron, samarium or cadmium.

In some embodiments, a molten salt chamber comprises a metal with a diamond coating comprising diamond embedded, forged, or cast into the metal. In some embodiments, a molten salt chamber comprises a metal with a diamond coating that includes a diamond powder.

In some embodiments, a molten salt chamber comprises a metal with a diamond coating that includes a monocrystal layer that is grown on the internal surface of the molten salt chamber. In some embodiments, a molten salt reactor comprises a packed bed of diamond particles disposed within the molten salt chamber.

In some embodiments, a molten salt reactor comprises a reflector disposed around the molten salt chamber and comprises a diamond and lead material.

Some embodiments include a molten salt reactor comprising: a molten salt chamber; a packed bed of diamond particles disposed within the molten salt chamber; and a molten salt mixture disposed within the molten salt chamber along with the diamond powder.

In some embodiments, a molten salt mixture is disposed between the spaces of the diamond particles within the packed bed of diamond particles. In some embodiments, a molten salt chamber comprises TZM, molybdenum, silicon carbide, graphite, or any combination thereof. In some embodiments, a molten salt mixture comprises either thorium or uranium. In some embodiments, a molten salt mixture comprises a molten salt eutectic.

In some embodiments, a molten salt reactor comprises a heat exchanger subsystem integrated with the molten salt chamber.

In some embodiments, a molten salt reactor comprises a perforated separator disposed above the packed bed of diamond particles, the perforated separator having a plurality of perforations. In some embodiments, the perforated separator is positioned within the molten salt chamber such that there is a portion of the chamber above the perforated separator that does not include the diamond particles.

In some embodiments, a molten salt reactor comprises: a shutdown rod channel that extends into the molten salt chamber; and a shutdown rod comprising a neutron dampening material disposed relative to the shutdown rod channel such that the shutdown rod can be moved into and out of the shutdown rod channel. In some embodiments, a molten salt reactor comprises a magnet coupled with the shutdown rod, the magnet holding the shutdown rod in a position where the shutdown rod does not extend into the molten salt chamber, the magnet having a curie temperature that is at or below the critical safety temperature of the molten salt mixture or molten salt chamber such that when the temperature of the magnet is at or near the critical safety temperature, the magnetic field is weakened sufficiently to allow the shutdown rod is allowed to move into the shutdown rod channel. The magnet may be selected to ensure the curie temperature is less than the critical safety temperature of the molten salt mixture and/or the molten salt chamber. In some embodiments, the shutoff rod comprises boron, samarium or cadmium. The magnet may have a curie temperature and/or configuration relative to the critical safety temperature such that the magnet may release at or near the critical safety temperature.

Some embodiments include a molten salt reactor comprising: a neutron poison chamber coupled with or disposed within the molten salt chamber and having a cavity that is in communication with the molten salt chamber with the molten salt chamber; a neutron poison disposed within the cavity of the neutron poison chamber; and a thermal safety failsafe disposed between and separating the neutron poison and the molten salt chamber, the molten salt poison having a melting point at or below a critical safety temperature of the molten salt mixture, thermal safety failsafe disposed relative to thermal safety failsafe such that when thermal safety failsafe melts, the neutron poison flows from the neutron poison chamber into the molten salt chamber. In some embodiments, a molten salt reactor comprises a reflector disposed around the molten salt chamber and comprises a diamond and lead material.

Some embodiments include a molten salt reactor comprising: a molten salt chamber; a molten salt mixture disposed within the molten salt chamber; a shutdown rod channel that extends into the molten salt chamber; a shutdown rod comprising a neutron dampening material disposed relative to the shutdown rod channel such that the shutdown rod can be moved into and out of the shutdown rod channel; and a magnet (or electromagnet) coupled with the shutdown rod, the magnet holding the shutdown rod in a position where the shutdown rod does not extend into the molten salt chamber, the magnet having a curie temperature that is at or below the critical safety temperature of the molten salt mixture or molten salt chamber such that when the temperature of the magnet is at or near the critical safety temperature, the magnetic field is weakened sufficiently to allow the shutdown rod moves into the shutdown rod channel.

In some embodiments, a molten salt reactor comprises a packed bed of diamond particles disposed within the molten salt chamber. In some embodiments, a molten salt chamber comprises TZM, molybdenum, silicon carbide, graphite, or any combination thereof. In some embodiments, a molten salt mixture comprises either thorium or uranium. In some embodiments, a molten salt mixture comprises a molten salt eutectic. In some embodiments, a molten salt reactor comprises a heat exchanger subsystem integrated with the molten salt chamber.

In some embodiments, the shutdown rod comprises boron, samarium or cadmium. In some embodiments, a molten salt reactor comprises a reflector disposed around the molten salt chamber and comprises a diamond and lead material.

Some embodiments include a shutdown mechanism comprising: a reactor chamber; a coolant subsystem that flows a liquid coolant through one or more channels that are inserted within portions of the reactor chamber and outside the reactor chamber; and a neutron poison failsafe disposed within the coolant subsystem such that when the coolant is flowing through the coolant subsystem the neutron poison failsafe is disposed at a first location within portions of the coolant subsystem that does not cause the neutron poison failsafe to inhibit a reaction within the reactor chamber, and when the coolant is not flowing through the coolant subsystem the neutron poison failsafe is disposed at a second location within portions of the coolant subsystem that cause the neutron poison failsafe to inhibit a reaction within the reactor chamber.

In some embodiments, the reactor chamber comprises a molten salt chamber comprising a molten salt disposed with the reactor chamber.

In some embodiments, the first location is in a portion of the of the coolant subsystem that is within the reactor chamber and the second location is in a portion of the of the coolant subsystem that is outside the reactor chamber. In some embodiments, the first location is a location with low neutron flux and the second location is a location with high neutron flux.

In some embodiments, the neutron poison failsafe transitions from the first location to the second location via gravitational force. In some embodiments, the neutron poison failsafe transitions from the second location to the first location via the coolant flowing through the coolant subsystem. In some embodiments, the neutron poison failsafe comprises tungsten.

In some embodiments, the density of the neutron poison failsafe is greater than the density of the coolant.

In some embodiments, the one or more channels comprises an outer channel and an inner channel; and the neutron poison failsafe comprises an annular ring that surrounds the inner channel.

In some embodiments, a molten salt chamber includes one or more standoffs disposed within the one or more channels in a region with high neutron flux.

In some embodiments, a molten salt reactor comprises a guide rod disposed within one of the one or more channels, and wherein the neutron poison failsafe includes an aperture through which the guide rod extends.

Some embodiments include an off-gas system comprising: a first chamber; a volatile fission product input port coupled with the first chamber; a first pressure sensor disposed to measure the pressure within the first chamber; a second chamber; a first valve coupled with the first chamber and the second chamber, and in communication with the first pressure sensor, the valve is opened when the first pressure sensor measures a pressure within the first chamber that is greater than a first predetermined pressure.

In some embodiments, a molten salt reactor comprises a reactor chamber having a chamber wall, wherein at least the first chamber and the second chamber are disposed within the chamber wall.

In some embodiments, the first valve comprises a pressure relief valve. In some embodiments, the first valve is mechanically actuated or pneumatically actuated. In some embodiments, the first valve is electrically actuated.

In some embodiments, a molten salt reactor comprises: a third chamber; a second pressure sensor disposed to measure the pressure within the second chamber; and a second valve coupled with the second chamber and the third chamber. In some embodiments, the first valve and the second valve are never opened at the same time during normal operations. In some embodiments, the first chamber and the second chamber are disposed in a radial pattern on a reactor.

A molten salt reactor is disclosed. The molten salt reactor may include a pool type, liquid metal, cooled, micro, molten salt reactor.

Some embodiments include a molten salt reactor comprising a molten salt chamber having an internal surface; a diamond coating covering the internal surface of the molten salt chamber; and a molten salt mixture disposed within the molten salt chamber.

In some embodiments, the molten salt chamber comprises a metal (e.g., TZM) and the diamond coating comprises diamond embedded, forged, or cast into the metal.

In some embodiments, the diamond coating comprises a diamond powder. In some embodiments, the diamond coating comprises a monocrystal layer that is grown on the internal surface.

In some embodiments, the molten salt comprises thorium or uranium. In some embodiments, the molten salt reactor may include a plurality of fins 125 on the external surface of the molten salt chamber.

In some embodiments, the molten salt reactor may include a heat exchanger subsystem.

In some embodiments, the molten salt reactor may include a shutdown rod that when actuated into the molten salt chamber the fission reaction within the molten salt mixture is stopped and when actuated out of the molten salt chamber the fission reaction within the molten salt mixture proceeds. In some embodiments, the shutoff rod comprises boron.

Some embodiments include a molten salt reactor comprising a molten salt chamber; a molten salt mixture disposed within the molten salt chamber; and a thermal safety failsafe disposed within the molten salt chamber having a melting point at or above a critical safety temperature of the molten salt mixture; and a neutron poison disposed between the thermal safety failsafe and the molten salt mixture that is released into the molten salt mixture when the thermal safety failsafe melts.

In some embodiments, the neutron poison comprises samarium. In some embodiments, the neutron poison comprises boron, boron carbide, gadolinium, or tungsten. In some embodiments, thermal safety failsafe has a melting point between about 1,000° C.-1,300° C.

In some embodiments, the molten salt reactor may include an exchanger manifold, wherein the thermal safety failsafe and the neutron poison are disposed within or coupled with the exchanger manifold.

Some embodiments include a molten salt reactor comprising: a molten salt chamber; a molten salt mixture disposed within the molten salt chamber; and a structural matrix having a plurality of molten salt channels where the molten salt is disposed.

In some embodiments, the structural matrix comprises a plurality of reactor plates being stacked together with a space between each of the plurality of reactor plates. In some embodiments, each of the plurality of reactor plates comprise a plurality of molten salt channels. In some embodiments, the surfaces of the structural matrix have a diamond coating. In some embodiments, the structural matrix is disposed in a portion of the molten salt chamber. In some embodiments, the structural matrix comprises a plurality of heat exchanger channels for removing heat from the molten salt eutectic.

In some embodiments, the structural matrix comprises a plurality of reactor plates being stacked together with a space between each of the plurality of reactor plates. In some embodiments, each of the plurality of reactor plates comprise a plurality of heat exchanger channels.

In some embodiments, a molten salt reactor may include a molten salt chamber; a molten salt mixture disposed within the molten salt chamber; a neutron poison chamber coupled with or disposed within the molten salt chamber and having a cavity that is in communication with the molten salt chamber with the molten salt chamber; a neutron poison disposed within the cavity of the neutron poison chamber; and a thermal safety failsafe disposed between and separating the neutron poison and the molten salt chamber. The molten salt poison may have a melting point at or below a critical safety temperature of the molten salt mixture, the thermal safety failsafe disposed relative to the thermal safety failsafe such that when the thermal safety failsafe melts, the neutron poison flows from the neutron poison chamber into the molten salt chamber.

In some embodiments, the neutron poison comprises samarium. In some embodiments, the neutron poison comprises boron or gadolinium. In some embodiments, the neutron poison comprises a plurality of spheres (e.g., small spheres).

In some embodiments, the thermal safety failsafe has a melting point between about 1,000° C.-1,300° C.

In some embodiments, the molten salt reactor may include a heat exchanger manifold. The thermal safety failsafe and/or the neutron poison may be disposed within or coupled with the exchanger manifold. In some embodiments, thermal safety failsafe comprises solder that melts at the critical safety temperature of the molten salt eutectic.

In some embodiments, the molten salt reactor may include a shutdown rod channel that extends into the molten salt chamber; and a shutdown rod comprising a neutron dampening material disposed relative to the shutdown rod channel such that the shutdown rod can be moved into and out of the shutdown rod channel.

In some embodiments, the molten salt reactor may include an magnet (or electromagnet) coupled with the shutdown rod. The magnet may hold the shutdown rod in a position so that the shutdown rod does not extend into the molten salt chamber. The magnet may have a curie temperature that is at or below a critical safety temperature of the molten salt chamber such that when the temperature of the magnet is at or near the critical safety temperature, the magnetic field is weakened sufficiently to allow the shutdown rod to move into the shutdown rod channel. The of the critical safety temperature of the magnet may depend on the critical safety temperature of the molten salt, the location of the magnet relative to the molten salt, the heat diffusion between the magnet and the molten salt, etc. The magnet may have a curie temperature and/or configuration relative to the critical safety temperature such that the magnet may release at or near the critical safety temperature.

In some embodiments, the shutdown rod comprises boron, samarium or cadmium.

In some embodiments, the molten salt chamber comprises a metal with a diamond coating comprising diamond embedded, forged, or cast into the metal. In some embodiments, the molten salt chamber comprises a metal with a diamond coating that includes a diamond powder. In some embodiments, the molten salt chamber comprises a metal with a diamond coating that includes a monocrystal layer that is grown on the internal surface of the molten salt chamber.

In some embodiments, the molten salt reactor may include a packed bed of diamond particles disposed within the molten salt chamber.

In some embodiments, the molten salt reactor may include a reflector disposed around the molten salt chamber and/or comprises a diamond and lead material.

Some embodiments include a molten salt reactor comprising a molten salt chamber; a packed bed of diamond particles disposed within the molten salt chamber; and a molten salt mixture disposed within the molten salt chamber along with the diamond powder.

In some embodiments, the molten salt mixture is disposed between the spaces of the diamond particles within the packed bed of diamond particles.

In some embodiments, the molten salt chamber comprises TZM, molybdenum, silicon carbide, graphite, or any combination thereof.

In some embodiments, the molten salt mixture comprises either thorium or uranium.

In some embodiments, the molten salt mixture comprises a molten salt eutectic.

In some embodiments the molten salt reactor may include a heat exchanger subsystem integrated with the molten salt chamber.

In some embodiments the molten salt reactor may include a perforated separator disposed above the packed bed of diamond particles, the perforated separator having a plurality of perforations.

In some embodiments, the perforated separator may be positioned within the molten salt chamber such that there is a portion of the chamber above the perforated separator that does not include the diamond particles.

In some embodiments the molten salt reactor may include a shutdown rod channel that extends into the molten salt chamber; and/or a shutdown rod comprising a neutron dampening material disposed relative to the shutdown rod channel such that the shutdown rod can be moved into and out of the shutdown rod channel.

In some embodiments the molten salt reactor may include an magnet (or electromagnet) coupled with the shutdown rod. In some embodiments, the magnet may hold the shutdown rod in a position where the shutdown rod does not extend into the molten salt chamber. The magnet may have a curie temperature that is at or below the critical safety temperature of the molten salt or the molten salt chamber. When the temperature of the magnet is at or near the critical safety temperature, the magnetic field is weakened sufficiently to allow the shutdown rod to move into the shutdown rod channel. The magnet may have a curie temperature and/or configuration relative to the critical safety temperature such that the magnet may release at or near the critical safety temperature.

In some embodiments, the shutoff rod comprises boron, samarium or cadmium.

In some embodiments the molten salt reactor may include a neutron poison chamber coupled with or disposed within the molten salt chamber and having a cavity that is in communication with the molten salt chamber with the molten salt chamber; a neutron poison disposed within the cavity of the neutron poison chamber; and/or a thermal safety failsafe disposed between and separating the neutron poison and the molten salt chamber. The molten salt poison may have a melting point at or below a critical safety temperature of the molten salt mixture. The thermal safety failsafe may be disposed relative to the thermal safety failsafe such that when the thermal safety failsafe melts, the neutron poison flows from the neutron poison chamber into the molten salt chamber.

In some embodiments, the molten salt reactor may include a reflector disposed around the molten salt chamber and comprises a diamond and lead material. In some embodiments, the molten salt reactor may include a reflector disposed around the molten salt chamber and comprises beryllium, a beryllium alloy, beryllium oxide, a beryllium compound, tungsten, a tungsten compound, graphite, diamond, silicon carbide, or water.

Some embodiments may include molten salt reactor comprising: a molten salt chamber; a molten salt mixture disposed within the molten salt chamber; a shutdown rod channel that extends into the molten salt chamber; a shutdown rod comprising a neutron dampening material disposed relative to the shutdown rod channel such that the shutdown rod can be moved into and out of the shutdown rod channel; and a magnet (or electromagnetically) coupled with the shutdown rod. The magnet may hold the shutdown rod in a position where the shutdown rod does not extend into the molten salt chamber. The magnet may have a curie temperature that is at or below the critical safety temperature of the molten salt mixture. When the temperature of the magnet is at or below the critical safety temperature, the magnetic field is weakened enough to allow the shutdown rod moves into the shutdown rod channel. The magnet may have a curie temperature and/or configuration relative to the critical safety temperature such that the magnet may release at or near the critical safety temperature.

In some embodiments the molten salt reactor may include a packed bed of diamond particles disposed within the molten salt chamber.

In some embodiments, the molten salt chamber comprises TZM, molybdenum, silicon carbide, graphite, or any combination thereof.

In some embodiments, the molten salt mixture comprises either thorium or uranium. In some embodiments, the molten salt mixture comprises a molten salt eutectic.

In some embodiments the molten salt reactor may include a heat exchanger subsystem integrated with the molten salt chamber.

In some embodiments, the shutdown rod comprises boron, samarium or cadmium.

In some embodiments the molten salt reactor may include a reflector disposed around the molten salt chamber and comprises a diamond and lead material.

These illustrative embodiments are mentioned not to limit or define the disclosure, but to provide examples to aid understanding thereof. Additional embodiments are discussed in the Detailed Description, and further description is provided there. Advantages offered by one or more of the various embodiments may be further understood by examining this specification or by practicing one or more embodiments presented.

### BRIEF DESCRIPTION OF THE FIGURES

These and other features, aspects, and advantages of the present disclosure are better understood when the following Detailed Description is read with reference to the accompanying drawings.

FIG. 1 is a side view of a molten salt reactor according to some embodiments.

FIG. 2 is diagram of a molten salt reactor according to some embodiments.

FIG. 3 is a diagram of a heat exchanger according to some embodiments.

FIG. 4 is a perspective view of the molten salt reactor according to some embodiments.

FIG. 5 is an illustration of cross sections of a portion of a packed bed of moderator particulates according to some embodiments.

FIG. 6 is an illustration of a portion of a packed bed of moderator particulates according to some embodiments.

FIG. 7 is a side view of a molten salt reactor with a plurality of neutron moderating structures according to some embodiments

FIG. 8 is an illustration of a molten salt chamber 800 with a salt mixture disposed within one or more shells according to some embodiments.

FIG. 9 is a side view of a heat exchange system for a molten salt chamber according to some embodiments.

FIG. 10 is a side view of a heat exchange system for a molten salt chamber according to some embodiments.

FIG. 11 is a side view of a heat exchange system for a molten salt chamber according to some embodiments.

FIG. 12 is an illustration of a molten salt reactor that includes a reflector according to some embodiments.

FIG. 13 is an illustration of a molten salt reactor that includes a reflector according to some embodiments.

FIG. 14 is an illustration of a thermally-activated failsafe including a hinged door with a thermally-activated latch according to some embodiments.

FIG. 15 is an illustration of the thermally-activated failsafe according to some embodiments.

FIGS. 16A, 16B, and 16C illustrate a thermally-activated failsafe according to some embodiments.

FIG. 17 is a side view diagram of a molten salt reactor with the thermally activated failsafe according to some embodiments.

FIGS. 18A, 18B, and 18C illustrate a thermally-activated failsafe according to some embodiments.

FIGS. 19A, 19B, and 19C illustrate a thermally-activated failsafe according to some embodiments.

FIG. 20 is a side view of a perforation in a perforated separator according to some embodiments.

FIG. 21 is a side view of the perforation in a perforated separator according to some embodiments.

FIGS. 22A, 22B, 22C, and 22D illustrate a neutron poison shutdown mechanism disposed within a coolant channel according to some embodiments.

FIGS. 23A and 23B illustrate a neutron poison shutdown mechanism within a coolant channel according to some embodiments.

FIG. 24 illustrates an off-gas release system according to some embodiments.

FIG. 25 illustrates an off-gas release system according to some embodiments.

FIG. 26 is diagram of a molten salt reactor according to some embodiments.

FIG. 27 is diagram of a molten salt reactor according to some embodiments.

FIG. 28 is a diagram of a heat exchanger according to some embodiments.

FIG. 29 is a diagram of a single reactor plate according to some embodiments.

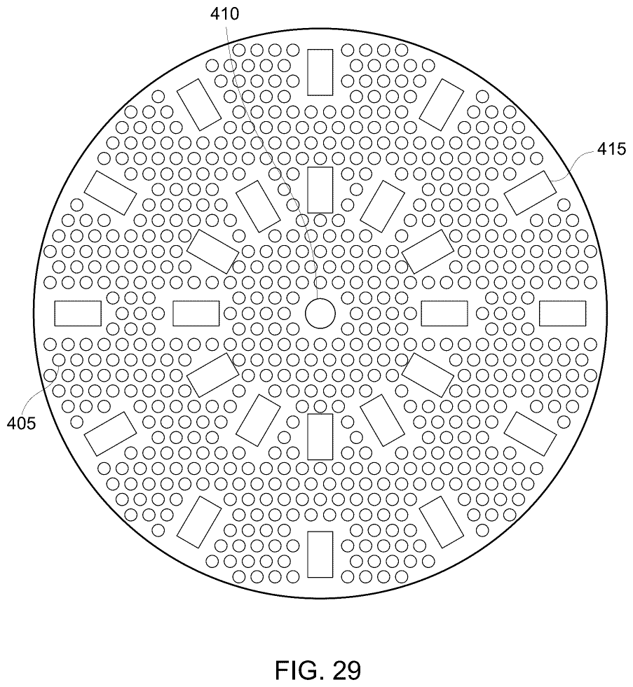

FIG. 30 is a diagram of a single reactor plate according to some embodiments.

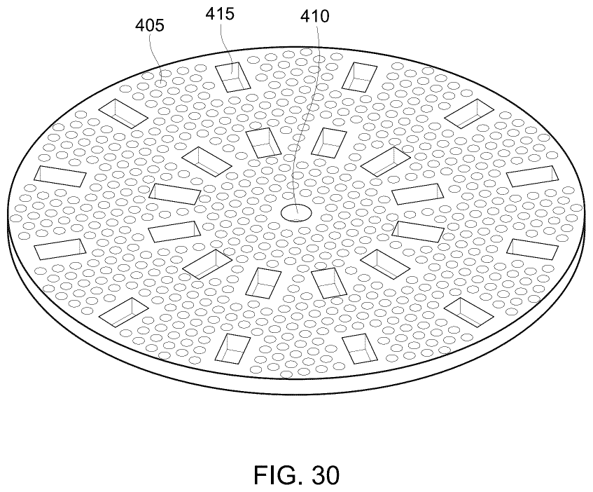

FIG. 31 is a diagram of a molten salt reactor according to some embodiments.

FIG. 32 is a side view and a perspective view of a diagram of a molten salt reactor coupled with a turbine according to some embodiments.

FIG. 33 illustrates a matrix of molten salt fuel section and diamond particle prisms according to some embodiments.

### DETAILED DESCRIPTION

Systems and methods are disclosed for a self-contained molten salt reactor. In some embodiments, the reactor may include a molten salt mixture (such as, for example, a molten salt eutectic) with a fissile material that may include uranium and thorium in a molten salt (e.g., 2% U, 29% Th, and 69% salt). The molten salt mixture may include, for example, NaFl, KFl, MgFl, CaFl. The self-contained molten salt reactor may have diamond coated surface, a shutdown rod, a heat exchange subsystem, and a thermal safety failsafe. In some embodiments, the self-contained molten salt reactor may have a diameter of about 2, 5, 10, 15 meters. The size of the self-contained molten salt reactor may depend on the reactive materials.

A molten salt reactor (or reactor) may include any type of molten salt fission device or system whether or not it includes a reactor. The reactor may include a liquid-salt very-high-temperature reactor, a liquid fluoride thorium reactor, a liquid chloride thorium reactor, a liquid salt breeder reactor, a liquid salt solid fuel reactor, a high flux water reactor with a high or low enriched uranium-salt target etc.
The molten salt fission reactor, for example, may employ one or more molten salts with a fissile material (e.g., molten salt mixture). The molten salt, for example, may include any salt comprising Fluorine, Chlorine, Lithium, Sodium, Potassium, Beryllium, Zirconium, Rubidium, etc., or any combination thereof. Some examples of molten salts may include LiF, LiF—BeF2, 2LiF—BeF2, LiF-BeF2-ZrF4, NaF—BeF2, LiF—NaF—BeF2, LiF—ZrF4, LiF—NaF—ZrF4, KF—ZrF4, RbF—ZrF4, LiF—KF, LiF—RbF, LiF—NaF—KF, LiF—NaF—RbF, BeF2-NaF, NaF—BeF2, LiF—NaF—KF, etc. In some embodiments, the molten salt may include sodium fluoride, potassium fluoride, aluminum fluoride, zirconium fluoride, lithium fluoride, beryllium fluoride, rubidium fluoride, magnesium fluoride, and/or calcium fluoride
In some embodiments, the molten salt mixture (such as, for example, a molten salt eutectic) may include any of the following possible salt mixtures or eutectics. Many other mixtures or eutectics may be possible. The following examples also include the melting point of the example eutectics. The molar ratios are examples only. Various other eutectics may be used.
LiF—NaF (60-40 mol %) 652° C.
LiF—KF (50-50 mol %) 492° C.
LiF—NaF—KF (46.5-11.5-42 mol %) 454° C.
LiF—NaF—CaF2 (53-36-11 mol %) 616° C.
LiF—NaF-MgF2-CaF2 (˜50-˜30-˜10-˜10 mol %)˜600° C.
LiF-MgF2-CaF2 (˜65-˜12-˜23 mol %) 650-725° C.

### LiF—BeF2 (66.5-33.5 mol %) 454° C.

### NaF—BeF2 (69-31 mol %) 570° C.

### LiF—NaF—BeF2 (15-58-27) 480° C.

### LiF—NaF—ZrF4 (37-52-11) 604° C.

### LiF—ThF4 (71-29) 565° C.

### NaF—ThF4 (77.5-22.5) 618° C.

### NaF—ThF4 (63-37) 690° C.

### NaF—ThF4 (59-41) 705° C.

### LiF—UF4 (73-27) 490° C.

### NaF—UF4 (78.5-21.5) 618° C.

### LiF—NaF—UF4 (24.3-43.5-32.2) 445° C.

In some embodiments, the eutectic mixture (such as, for example, a molten salt eutectic) may comprise MgNaFK.

In some embodiments, the molten salt mixture may be mixed with various moderators such as, for example, a packed bed of diamond particles. Diamond, for example, has a high thermal conductivity and is made of carbon which can act as a neutron moderator. A packed bed of diamond particles may, for example, increase the thermal conductivity of the molten salt mixture within the reactor. This could, for example, allow for passive decay heat removal and conduction of heat through the core. In some embodiments, as heat is removed from the reactor, either by a coolant, or by natural cooling, the temperature of the reactor lowers. The neutron flux may speed up, for example, because the higher density of the fuel salt within the moderated portion of the reactor. As another example, the neutron flux may speed up because the higher density may result in neutrons that are more likely to collide with fissile material and cause fission to molten salt inside the moderated portion of the reactor shifting the neutron flux to a more thermalized spectrum causing more total fissions to occur.

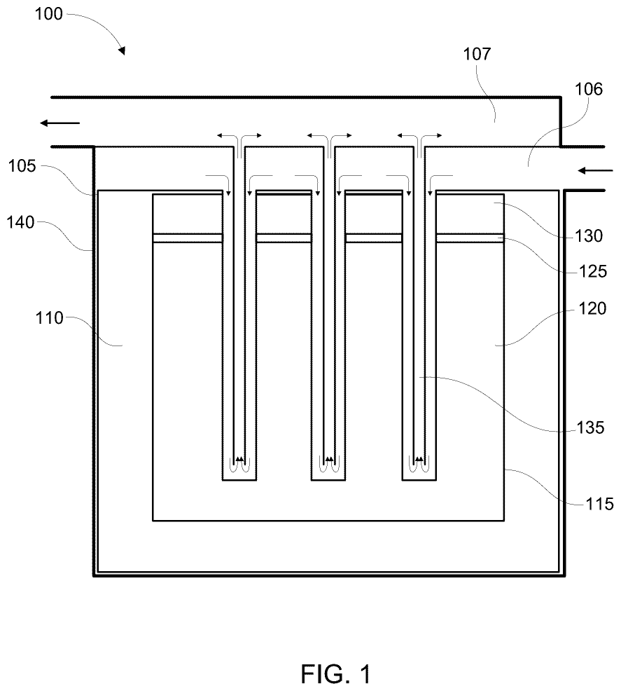

FIG. 1 is a side view diagram of a molten salt reactor 100 according to some embodiments. The molten salt reactor 100 may include a containment vessel 105. The containment vessel 105, for example, may comprise a material that resists corrosion from the environment at the molten salt reactor operating temperature while also effectively retaining radioactive material (including fission products) within the containment vessel thus creating a barrier to the release of radioactive material (including fission products). The containment vessel 105, for example, may comprise a material with an ASME code case. The containment vessel 105, for example, may comprise molybdenum, tungsten, TZM, stainless steel (e.g., stainless steel 316), a nickel-based alloy, Inconel, Hastelloy-N, silicon carbide, etc. or any combination thereof.

In some embodiments, the containment vessel 105 may include a coating 140 on the outer surface of the containment vessel 105. The coating 140 may be a copper coating.

In some embodiments, a reflector 110 may be disposed within the containment vessel 105. The reflector 110, for example, may include a lead and/or diamond mixture. The reflector 110, for example, may be created by melting lead into diamond particles.

A molten salt chamber 120 may be disposed within the molten salt reactor 100 surrounded by and/or disposed within the containment vessel 105 and/or the reflector 110. The molten salt chamber 120 may include any chamber or vessel that holds molten salt The molten salt chamber 120 may have a chamber wall 115 that comprises TZM, molybdenum, silicon carbide, graphite, or any combination thereof. The molten salt chamber 120, for example, may be made of a material that substantially resists corrosion from contact with the molten salt mixture. The molten salt chamber 120, for example, may be made of a material that substantially resists corrosion from contact with the fuel-bearing molten salt mixture for example molybdenum or silicon carbide. The chamber wall 115, for example, may comprise reactor-grade graphite and/or silicon carbide.

For example, the chamber wall 115 may have a coating that resists corrosion from contact with the molten salt mixture (e. g. a diamond embedded molten salt chamber wall). As another example, the chamber wall 115 may have a coating that resists corrosion from contact with the molten salt mixture (e. g. diamond coating on the inner surface of the molten salt chamber wall). For example, the coating can be applied on the chamber wall 115 by a high-temperature deposition of diamond crystal coating a methane and hydrogen atmosphere in the substantial absence of nitrogen.

In some embodiments, the molten salt reactor 100 may include a heat exchange system. The heat exchange system may include a coolant inlet 106, a coolant outlet 107, and/or one or more coolant channels 2835 that extend into the molten salt chamber 120. Coolant may flow into the into the molten salt reactor 100 via the coolant inlet 106, flow into the coolant channels 135, and exit via the coolant outlet 107. The coolant may include a liquid metal coolant. The coolant within the one or more coolant channels 2835 may be in thermal contact with the molten salt.

In some embodiments, the molten salt chamber 120 and the containment vessel 105 are the same vessel/chamber.

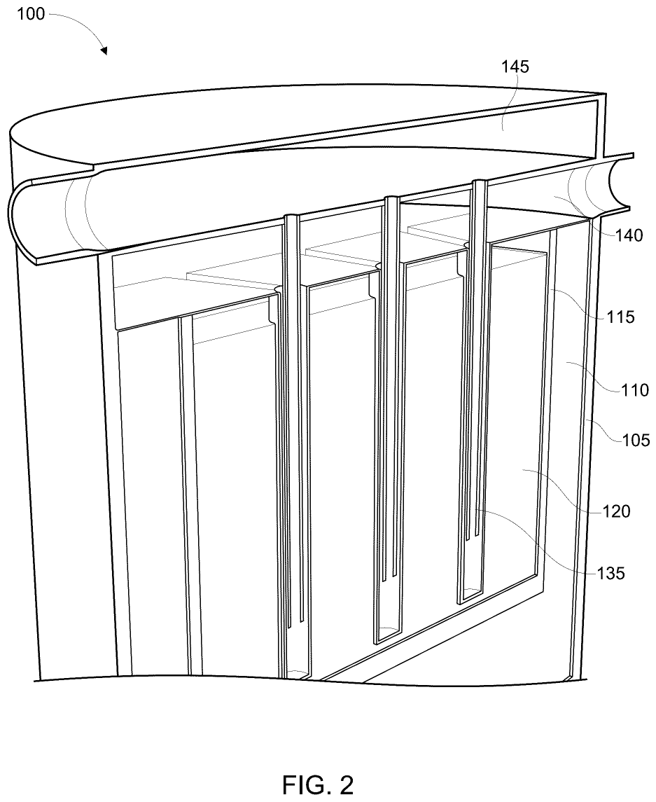

FIG. 2 is a perspective view of the molten salt reactor 100. In this view, the coolant is not shown in the drawing.

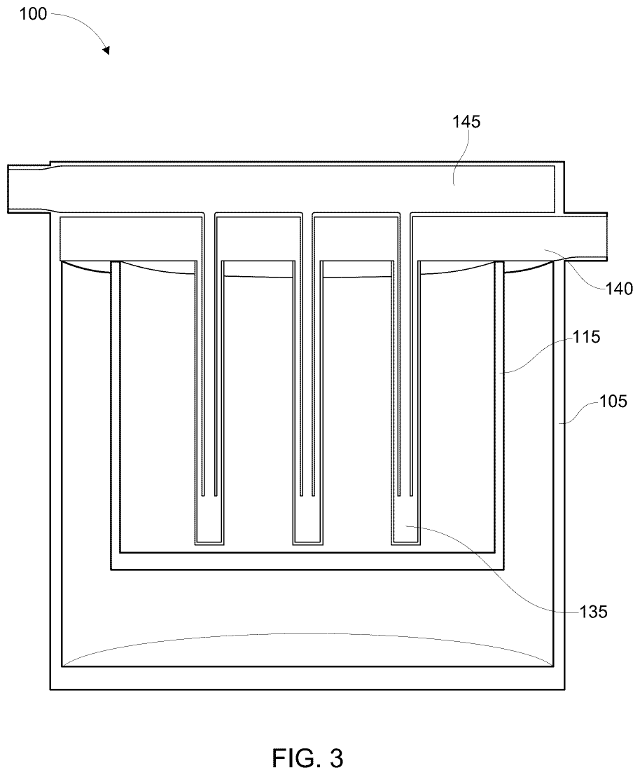

FIG. 3 is a side view of the molten salt reactor 100. In this view, the molten salt mixture is not disposed within the molten salt chamber and the reflector 110 is not illustrated in the drawing.

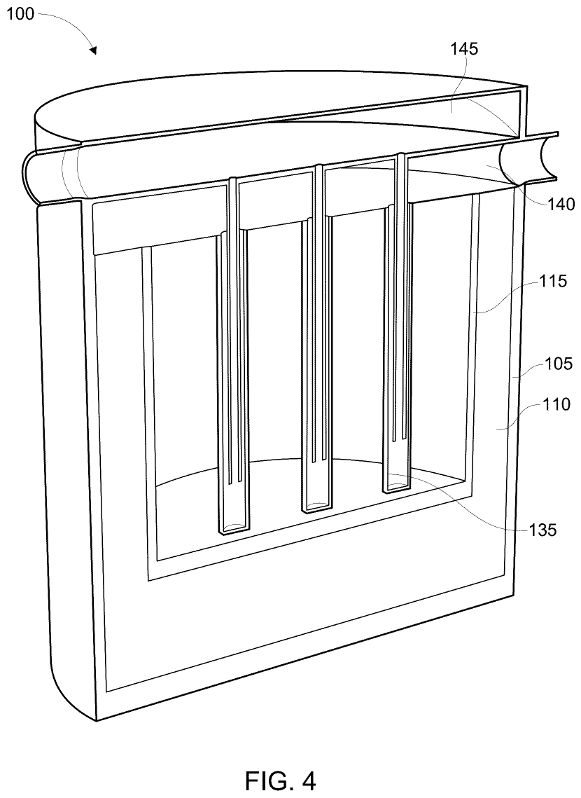

FIG. 4 is a perspective view of the molten salt reactor 100. In this view, the coolant fluid and the molten salt is not illustrated in the drawing.

A molten salt mixture may be disposed within the molten salt chamber 120. The molten salt mixture may, for example, include any molten salt mixture such as, for example, those described in this document. The molten salt mixture, for example, may include any molten salt with thorium or uranium. The molten salt mixture, for example, may include any molten salt may include a fluoride or chloride salt.

For example, the molten salt mixture may comprise one or more of the following salts NaF, MgF2, KF, ThF4, BeF2, LiF, CaF2, and/or UF4. For example, the molten salt mixture may comprise one or more of the following salts NaF, MgF2, KF, CaF2, ThF4, and/or UF. For example, the molten salt mixture may comprise one or more of the following salts NaF, MgF2, KF, ThF4, and/or UF4.

In some embodiments, the molten salt mixture may include neutron moderators and/or thermal conductivity enhances. The molten salt mixture, for example, may include moderator particulates within the molten salt mixture such as, for example, diamond, graphite, and/or silicon carbide. The molten salt mixture, for example, may include a plurality of particulates that are all approximately the same size or have different sizes. The molten salt mixture, for example, may include a packed bed of moderator particulates. The molten salt mixture, for example, may include a packed bed of moderator particulates having a high packing fraction.

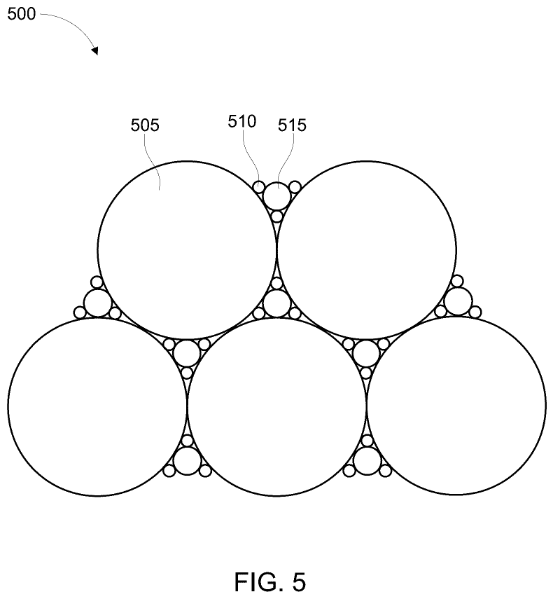

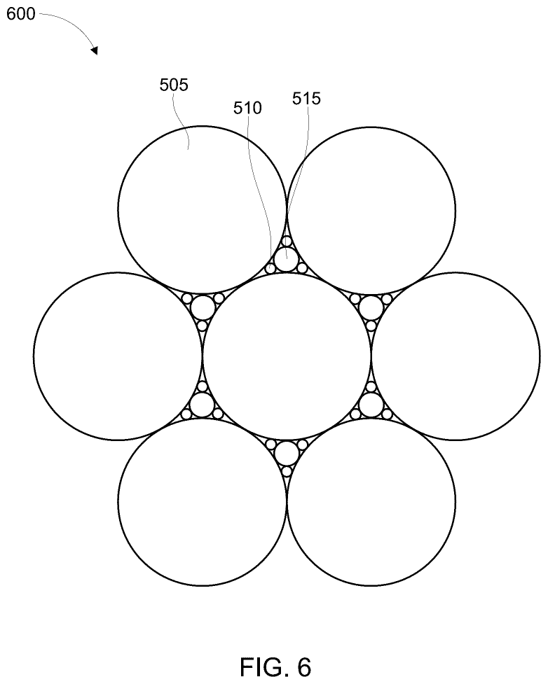

FIG. 5 shows cross sections of a portion of a packed bed of moderator particulates 500 that includes a first plurality of moderator particulates 505 having a first size, a second plurality of moderator particulates 510 having a second size, and/or a third plurality of moderator particulates 515 having a third size. The first size may be substantially larger than the second size and/or the third size. The second size and/or the third size may comprises sizes that allow the particles to fit within gaps or spaces formed between adjacent particulates of the first plurality of particulates 505. FIG. 6 shows cross sections of a portion of a packed bed of moderator particulates 600 that includes a different arrangement of the first plurality of moderator particulates 505, the second plurality of moderator particulates 510, and/or the third plurality of moderator particulates 515. For example, the second plurality of moderator particulates 510 may comprise 35 mesh particulates and/or the third plurality of moderator particulates 515 may comprise 40 mesh particulates. As another example, the second plurality of moderator particulates 510 may comprise 230 mesh particulates and/or the third plurality of moderator particulates 270 may comprise 40 mesh particulates. As another example, the second plurality of moderator particulates 510 and/or the third plurality of moderator particulates 270 may comprise 600 mesh particulates.

In some embodiments, the molten salt mixture may be mixed with a packed bed of moderator particles. The molten salt may fill in the gaps between the different moderator particles of the packed bed of moderator particles. For example, a packed bed of similarly sized moderator particles can fill about 50% of the volume of the molten salt chamber. As another example, a packed bed of differently sized moderator particles can fill more than about 50% (e.g., about 75% of the volume) of the volume of the molten salt chamber. The packed bed of moderator particles, for example, may include diamond particles. The packed bed of moderator particles, for example, may have the following screen sizes: 35/40, 230/270, 600, etc.

A molten salt mixture (such as, for example, a molten salt eutectic) and packed bed of moderator particles, for example, may self-regulate a nuclear reaction such that the temperature of the reactor passively operates around a specific operating temperature. The specific operating temperature may depend, for example, on the packing fraction, density of the moderator (e.g., diamond, graphite, silicon carbide, yttrium hydride, etc.), and/or concentration of uranium or thorium in the reactor.

In some embodiments, the molten salt reactor 100 may include a burnable poison that can be used to decrease the reactivity swing over the reactor life. The burnable poison, for example, may comprise samarium fluoride, gadolinium fluoride, or boron carbide. The burnable poison, for example, may be interspersed throughout the molten salt mixture. The burnable poison, for example, may be contained in structures throughout the core such as, for example, a silicon carbide structure.

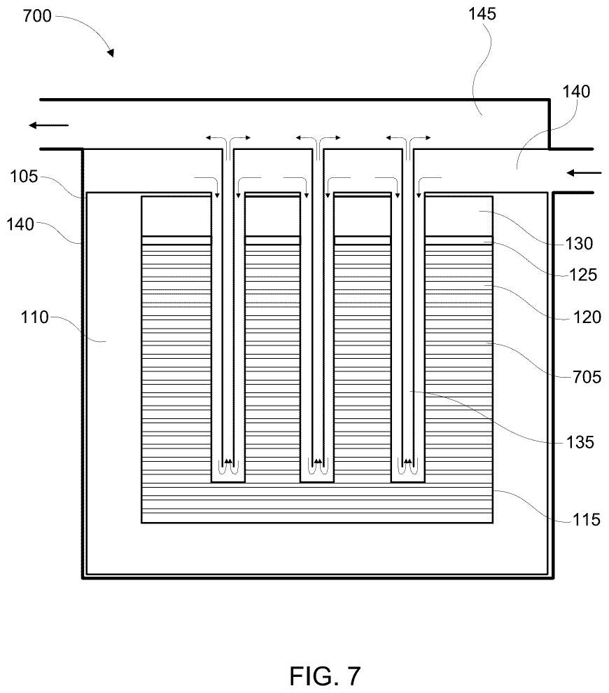

FIG. 7 is a sideview of a molten salt reactor 700 with a plurality of neutron moderating structures 705 according to some embodiments. The plurality of neutron moderating structures 705 may be disposed within the molten salt chamber 120. The plurality of neutron moderating structures 705, for example, may comprise a plurality of plates. The plurality of neutron moderating structures 705, for example, may comprise a prism pattern. The plurality of neutron moderating structures 705, for example, may comprise a material made of graphite, silicon carbide, diamond, or molybdenum. The plurality of neutron moderating structures 705, for example, may comprise diamond disposed within a shell of silicon carbide, graphite, or molybdenum. The plurality of neutron moderating structures 705, for example, may comprise diamond particles disposed within the neutron moderating structures. The plurality of neutron moderating structures 705, for example, may comprise a composite material including diamond and a binder material (e.g., silicon carbide, molybdenum, or graphite). The plurality of neutron moderating structures 705, for example, may comprise the neutron moderating structures comprise diamond and/or a liquid metal disposed within a shell (e.g., molybdenum, silicon carbide, or graphite).

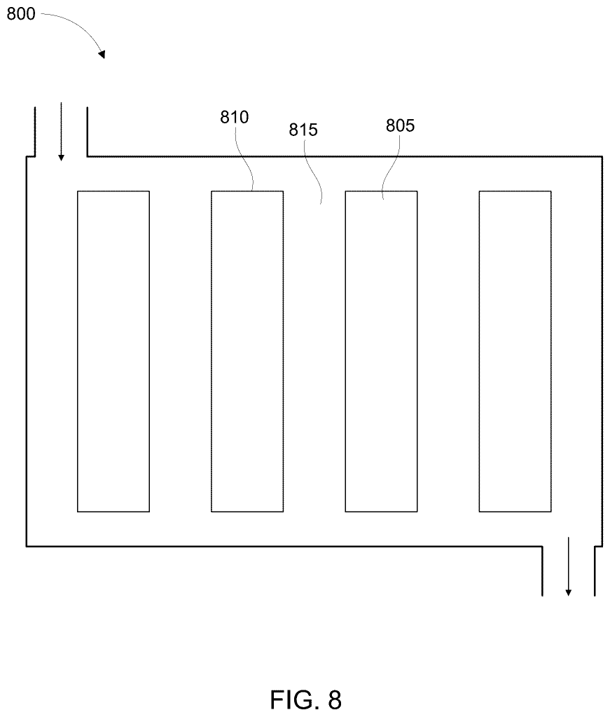

FIG. 8 is an illustration of a molten salt chamber 800 with a salt mixture 805 disposed within one or more shells 810 according to some embodiments. The shells may comprise a moderator material such as, for example, molybdenum, silicon carbide, or graphite and/or may include a liquid metal coolant 815 surrounding the shell.

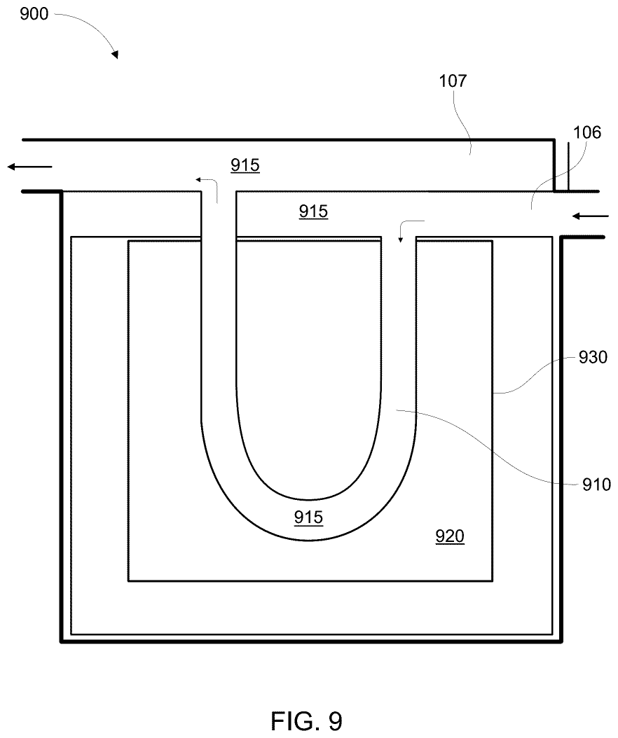

FIG. 9 is a side view of a heat exchange system for a molten salt chamber 900 according to some embodiments. The molten salt chamber 900 may include chamber walls 930 that contain molten salt 920. A heat exchange system may be disposed within the molten salt chamber to remove heat from the molten salt 920. Heat exchanger tubes 910 may be dispersed throughout the core. Some or all the components of the heat exchanger system such as, for example, the heat exchanger tubes 910 may comprise ASME code case material. The heat exchanger tubes 910, for example, are made of molybdenum.

In some embodiments, a coolant 915 may flow through the heat exchanger tubes 910 to remove heat from the molten salt chamber 900. The coolant 915, for example, may include a liquid metal such as, for example, lead, magnesium-aluminum, aluminum, silicone-aluminum, tin, etc.

In some embodiments, the heat exchanger tubes 910 may be shaped in a U-bend formation as shown in FIG. 9. The heat exchanger tubes 910, for example, may allow coolant to flow into and out of the molten salt chamber 900 via the same surface of the chamber walls 930.

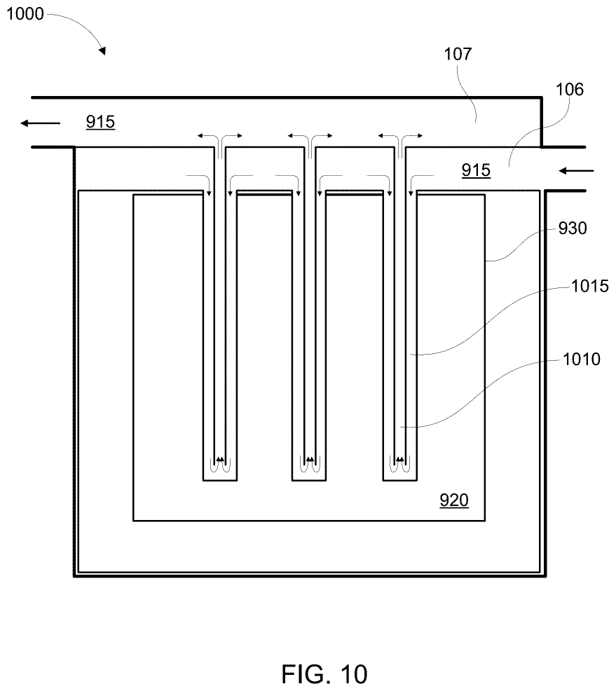

In some embodiments, a heat exchanger system 1000 may comprise concentric tubes as shown in FIG. 10 and FIG. 1. For example, the coolant may flow into the molten salt chamber 900 via an interior tube 1010 and flow out of the molten salt chamber 900 via an exterior tube 1015. The interior tube 1010 may be disposed within the exterior tube 1015. The concentric tubes may have any shape, length, and/or diameter.

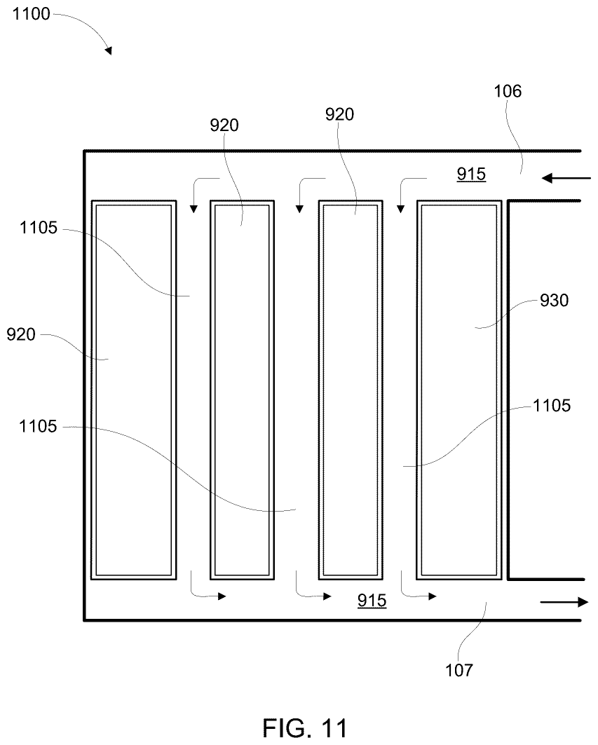

In some embodiments, a heat exchanger system 1100 may include a one or more heat exchanger tubes 1105 that flows in a substantially straight tube as shown in FIG. 11. The heat exchanger tubes 1105 may be coupled with coolant inlet 106 and/or coolant outlet 107. The heat exchanger tubes 1105, for example, may allow coolant to flow into and out of the molten salt chamber 900 via two different surfaces of the chamber walls.

In some embodiments, a molten salt reactor may include one or more shut down mechanisms. For example, a shutdown mechanism may include a neutron poison added to the coolant in the heat exchange system that shuts down the reaction. The neutron poison, for example, may include a liquid metal neutron poison.

In some embodiments, the neutron poison may be immiscible with the coolant. The neutron poison may include zinc and/or silver in a lead coolant. As another example, the neutron poison may include indium in an aluminum-based or in an aluminum-magnesium coolant. As another example, the liquid metal neutron poison may comprise indium or a mixture of indium and lead. Various other neutron poisons and/or coolant combinations may be used.

In some embodiments, the liquid metal neutron poison may have a high radiative capture cross section and/or a low melting point when combined with the coolant. (for example, the liquid metal neutron poison is indium). A high radiative capture cross section may include a radiative capture cross section greater than about 100 barns in a thermal spectrum and/or greater than about 0.1 barns (or greater than about 1 barns) in a fast spectrum. A low melting point may include a melting point less than about 260° C., 220° C., 200° C., or 180° C. low melting point may include a melting point less than about 260° C., 220° C., 200° C., or 180° C.

In some embodiments, a shutdown mechanism may include one or more shutdown rods of neutron-absorbing material that may be actuated into the molten salt chamber to inhibit the fission reaction and actuated out of the molten salt chamber to disinhibit the fission reaction. The shutdown rods, for example, may comprise boron, samarium, cadmium, boron carbide, tungsten carbide, silver, tungsten, samarium, gadolinium, etc.

In some embodiments, the molten salt reactor may include one or more shutdown rod channels that extend into molten salt chamber and allow actuation of the one or more shutdown rods into and out of the molten salt chamber. For example, the shutdown rod channels may comprise silicon carbide or molybdenum.

In some embodiments, one or more shutdown rods may be actuated into and/or out of the molten salt chamber using magnetic (or electromagnetic) forces. For example, one or more magnet when charged may retain a shutdown rod in a position wherein the shutdown rod does not extend into the molten salt chamber. The shutdown rod may be lowered into the molten salt chamber by interrupting the power supplied to the one or more magnet. The shutdown rod may automatically lower into the molten salt chamber when the power is interrupted via gravitational forces or a spring mechanism.

In some embodiments, a shutdown mechanism may include a plurality neutron-absorbing spheres (or shutdown spheres). The neutron absorbing spheres, for example, may comprise boron, samarium, cadmium, boron carbide, tungsten carbide, silver, tungsten, samarium carbide, gadolinium, etc. The neutron absorbing spheres, for example, may be positioned to be actuated into and/or out of the molten salt mixture and/or the molten salt chamber. When actuated into the molten salt mixture and/or the molten salt chamber, the neutron absorbing spheres, for example, may inhibit the fission reaction and when actuated out of the molten salt mixture and/or the molten salt chamber may disinhibit the fission reaction.

In some embodiments, a molten salt chamber may include one or more shutdown sphere channels that extend into the molten salt chamber and may allow the shutdown spheres to move into, through, and/or out of the shutdown sphere channels. The shutdown sphere channels may comprise, for example silicon carbide or molybdenum.

In some embodiments, the shutdown spheres may be placed in a shutdown sphere containment chamber outside the molten salt chamber during reactor operation. For example, the shutdown sphere containment chamber may include a helix shaped container. As another example, the shutdown sphere containment chamber may include a funnel shaped container.

In some embodiments, each of the plurality of shutdown spheres may be interconnected with a cable or string that can coil in the shutdown sphere containment chamber during reactor operation and extend into the molten salt chamber (e.g., within the shutdown sphere channel(s)) during shutdown.

In some embodiments, the shutdown spheres may be moved from the shutdown sphere containment chamber through the shutdown sphere channels via magnets.

In some embodiments, a liquid reservoir may be in communication with the shutdown sphere channels and include a valve to keep the liquid in the liquid reservoir from flowing into the shutdown sphere channels. The shutdown spheres may flow into the shutdown sphere channels by gravitational or magnetic forces to shut down the fission reaction and/or may be flushed from the shutdown sphere channels by opening the valve and allowing the liquid to flush or drain the shutdown spheres from the shutdown sphere channels.

In some embodiments, a door (or gate or valve) may be disposed between the shutdown sphere containment chamber and the shutdown sphere channels. The shutdown spheres may flow into the shutdown sphere channels when the door is opened.

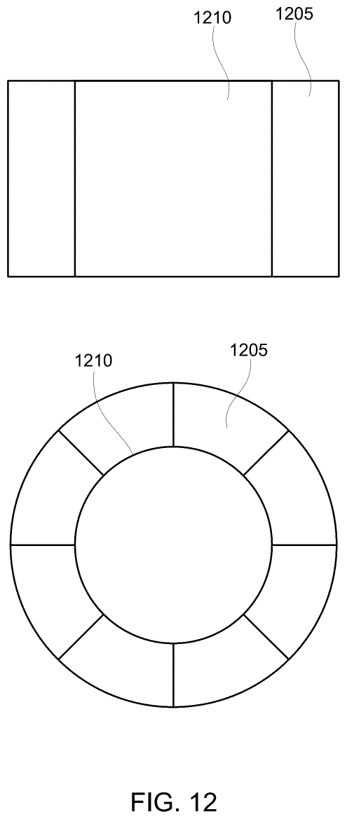

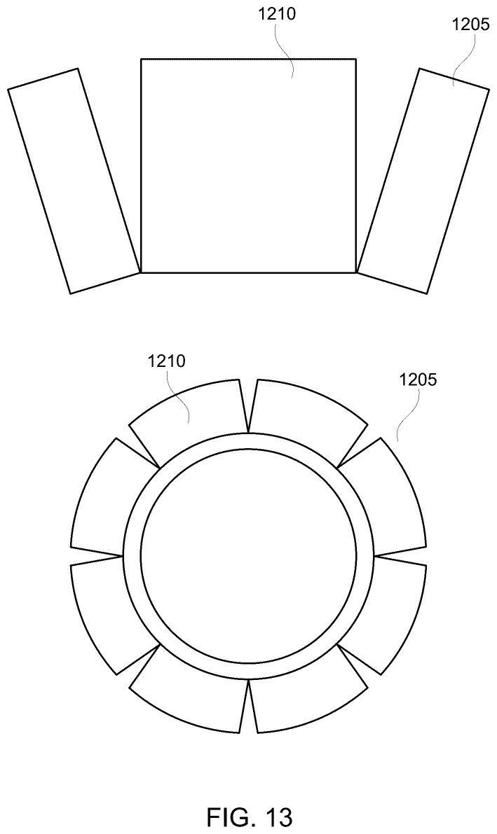

FIG. 12 is an illustration of a molten salt reactor that includes a reflector 1205 that reflects neutrons back into the molten salt chamber 1210 during a fission reaction. The reflector 1205 may allow the fission reaction to occur within the molten salt chamber 1210. The reflector 1205 may be moved or removed to inhibit the fission reaction such as, for example, during reactor shutdown. FIG. 13 shows the reflector 1205 moved or removed from the reflector 1205.

In some embodiments, a molten salt reactor may include a neutron poison chamber that contains a neutron poison. The neutron poison chamber may be thermally coupled with or disposed within the molten salt chamber. The neutron poison, for example, may comprise samarium, xenon, gadolinium, etc.). A release mechanism, for example, may be disposed between the molten salt chamber and/or the neutron poison chamber. The release mechanism may be activated when the temperature within the molten salt chamber exceeds or approaches a critical safety temperature.

In some embodiments, the neutron poison comprises small spherical pellets spheres (e.g., pellets or BBs).

In some embodiments, the release mechanism may melt at temperatures above the critical temperature causing the neutron poison to flow from the neutron poison chamber into the molten salt mixture or into a neutron poison channel. The release mechanism may be activated when the molten salt mixture reaches temperatures above about 1,000 C, 1,100 C, 1,200 C, 1,300 C, etc.

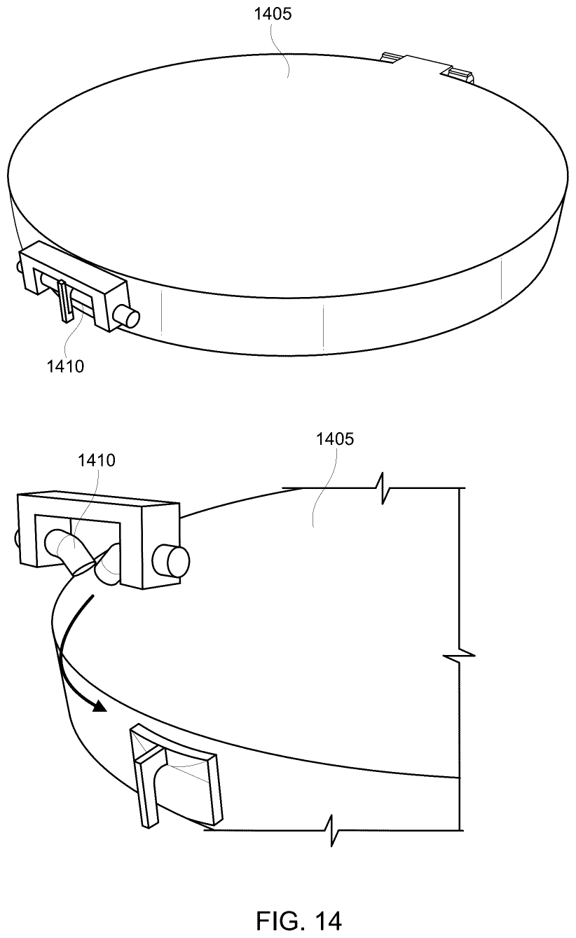

FIG. 14 is an illustration of a thermally-activated failsafe including a hinged door 1405 with a thermally-activated latch mechanism 1410 according to some embodiments. The thermally-activated failsafe may be disposed between and/or separating the neutron poison and the molten salt reactor. When the temperature exceeds the critical safety temperature, for example, the latch mechanism 1410 may release the hinged door 1405, which may be spring activated, and/or allow the hinged door 1405 to open; and allow the neutron poison to flow into the molten salt chamber.

In some embodiments, a thermally-activated failsafe may include a magnet that secures a hinged door or other mechanism in place. When the temperature reaches a temperature at or near the critical safety temperature, the magnet may lose magnetic force and allow the neutron poison to flow from the neutron poison chamber into the molten salt mixture or into a neutron poison channel. The hinged gate, for example, may swing under spring or gravitational forces when the temperature i.

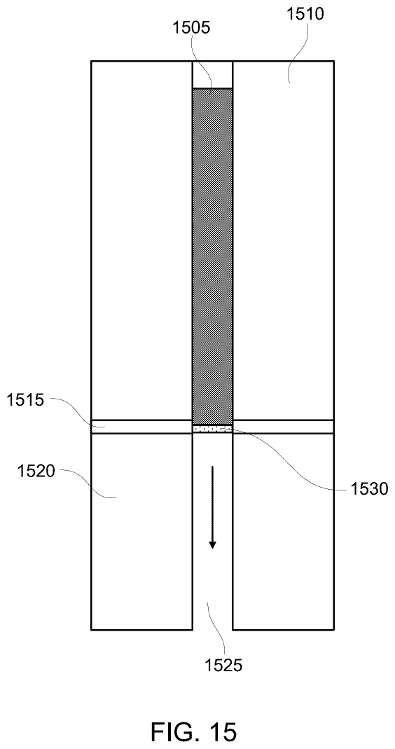

FIG. 15 is an illustration of the thermally-activated failsafe according to some embodiments. A neutron poison 1505 may be disposed within a channel in a manifold 1510. The manifold 1510 may be separated from the molten salt chamber 1520 via a molten salt chamber wall 1515. A neutron poison channel 1525, for example, may extend into the molten salt chamber 1520. The neutron poison 1505 may be separated from the neutron poison channel 1525 via a magnetic gate 1530. The magnetic gate 1530 may open at the critical safety temperature and/or the neutron poison 1505 may melt the critical safety temperature. The neutron poison 1505 may then flow into the neutron poison channel 1525 and may inhibit the fission reaction.

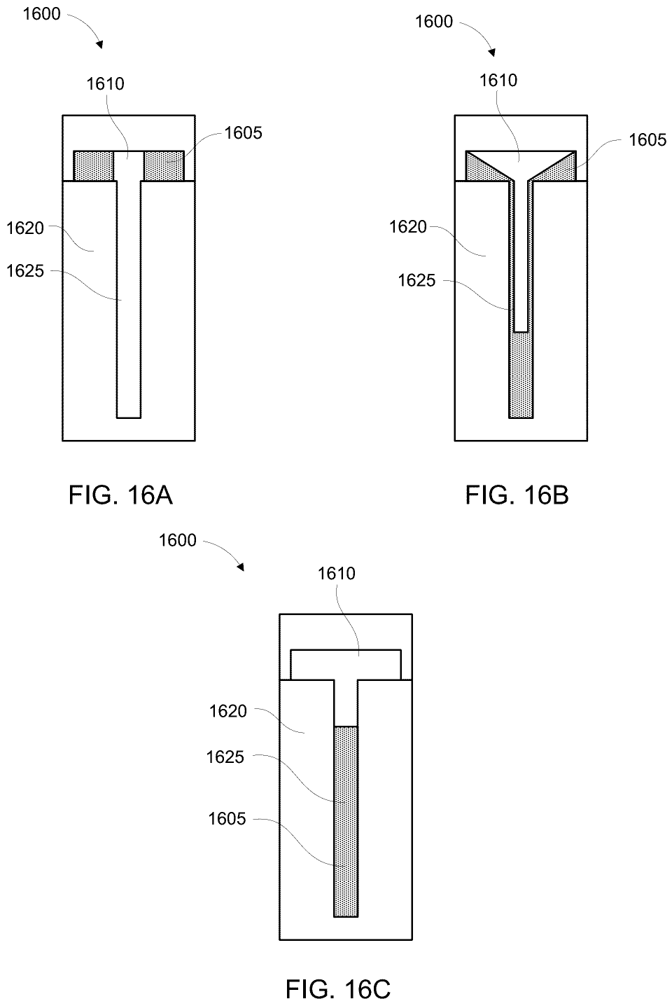

FIG. 16A is an illustration of a thermally-activated failsafe during normal operation temperatures within a molten salt chamber 1600 according to some embodiments. In this example, the neutron poison 1605 may be disposed in a neutron poison chamber 1610 and/or may comprise a solid ring of neutron poison disposed above the failsafe channel 1625. The neutron poison 1605 may include samarium or an alloy with samarium. The neutron poison 1605 may, for example, include an alloy that melts at temperatures above the critical safety temperature. The failsafe channel 1625 may extend into the molten salt mixture 1620 and/or molten salt chamber.

FIG. 16B is an illustration of the thermally-activated failsafe during operation temperatures above the critical operating temperature according to some embodiments. In this example, the neutron poison 1605 is melting and flowing into the failsafe channel 1625. In FIG. 16C all the neutron poison 1605 has melted and has flowed into the failsafe channel 1625.

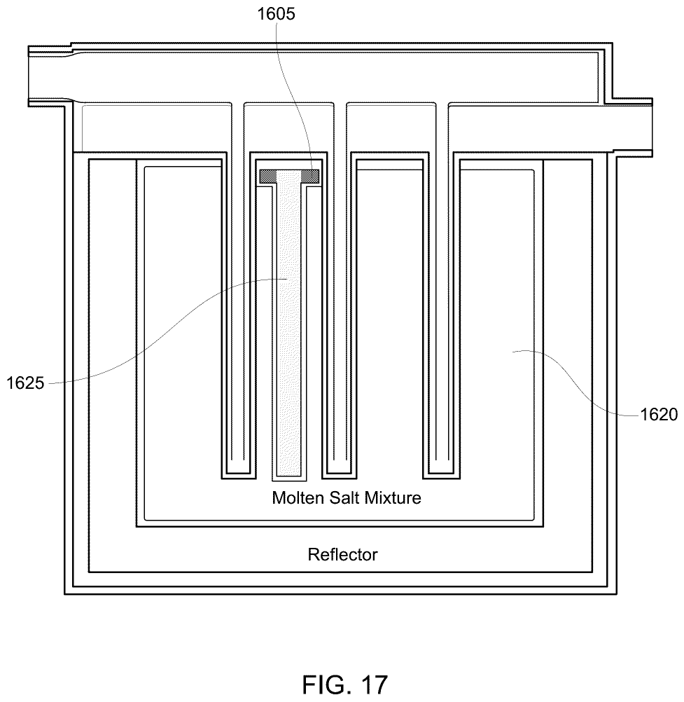

FIG. 17 is a side view diagram of a molten salt reactor with the failsafe channel 1625 such as, for example, the failsafe shown in FIG. 16A according to some embodiments. The failsafe channel 1625 extends into the molten salt chamber 120.

In some embodiments, the neutron poison may be released via a passively-activated failsafe (e.g., an electrical failure, a magnetic shutdown, etc.).

In some embodiments, the neutron poison may be released via a thermally-activated failsafe (e.g., freeze plug, melting release mechanism, etc.).

In some embodiments, a molten salt reactor my include a shutdown rod with an magnetic retention system that includes an magnet (or electromagnet). The magnetic field produced by the magnetic retention system, for example, may be heat dependent such as, for example, reduced magnetic fields are produced at temperatures at or near the critical safety temperature. The shutdown rod, for example, may be held in place outside the molten salt chamber by the magnetic retention system. When the temperature of the magnet is greater than the critical safety temperature, the magnetic force on the magnetic retention system (or the shutdown rod) is less than the force of gravity causing the shutdown rod to be released by the magnet and moving into a shutdown rod channel in the molten salt chamber.

In some embodiments, the magnetic retention system may retain shutdown spheres. The shutdown spheres, for example, may be held in place outside the molten salt chamber by the magnetic (or electromagnetic) retention system. When the temperature of the magnet is at or near a curie temperature, the magnetic force on the magnetic retention system is weakened sufficiently to allow the shutdown spheres to be released into a shutdown sphere channel in the molten salt chamber.

In some embodiments, a reflector may be released vie a thermally activated failsafe such as, for example, a thermally activated magnetic retention system.

In some embodiments, a plurality of failsafe mechanisms may be used. The plurality of failsafe mechanisms may be arranged next to each other, concentric relative to one another, dispersed, etc.

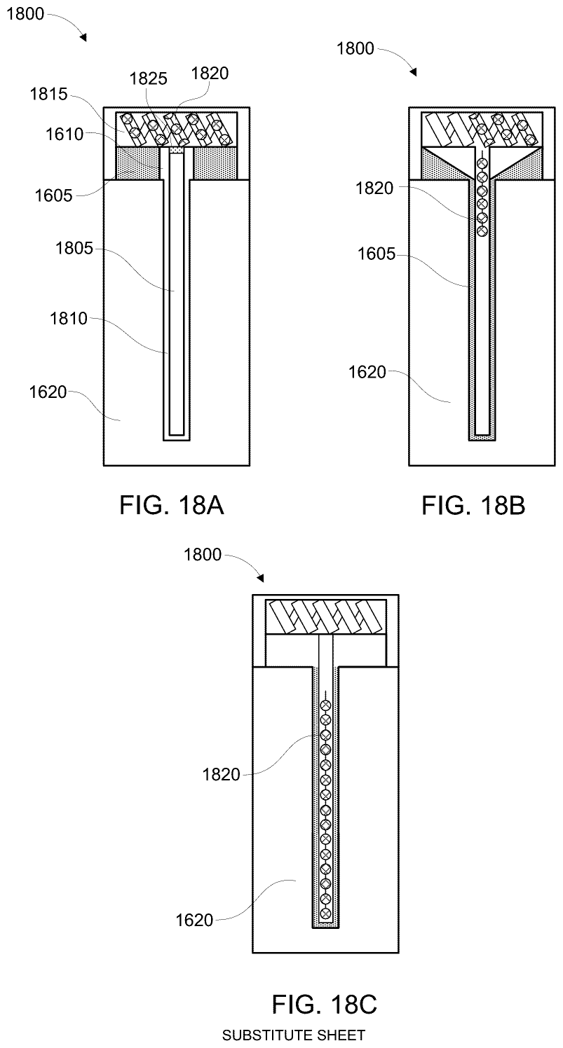

FIGS. 18A, 18B and 18C illustrate a molten salt chamber 1800 with a plurality of failsafe mechanisms. The plurality of failsafe mechanisms may be arranged next to each other, concentric relative to one another, dispersed, etc. The molten salt chamber 1800 includes an inner neutron poison channel 1805 and an outer neutron poison channel 1810. A neutron poison chamber 1610 can include solid neutron poison 1605 may be coupled with the inner neutron poison channel 1805. A sphere neutron poison chamber 1815 comprising a plurality of shutdown spheres 1820 disposed within a helix shaped container may be coupled with the outer neutron poison channel 1810 via a magnetic retention system 1825. As the temperature of the molten salt within the molten salt mixture 1620 increases toward or at the critical safety temperature, the neutron poison 1605 may melt and flow into the outer neutron poison channel 1810 and/or the magnetic retention system 1825 may open allowing the shutdown spheres 1820 to flow into the inner neutron poison channel 1805 as shown in FIG. 18B and FIG. 18C.

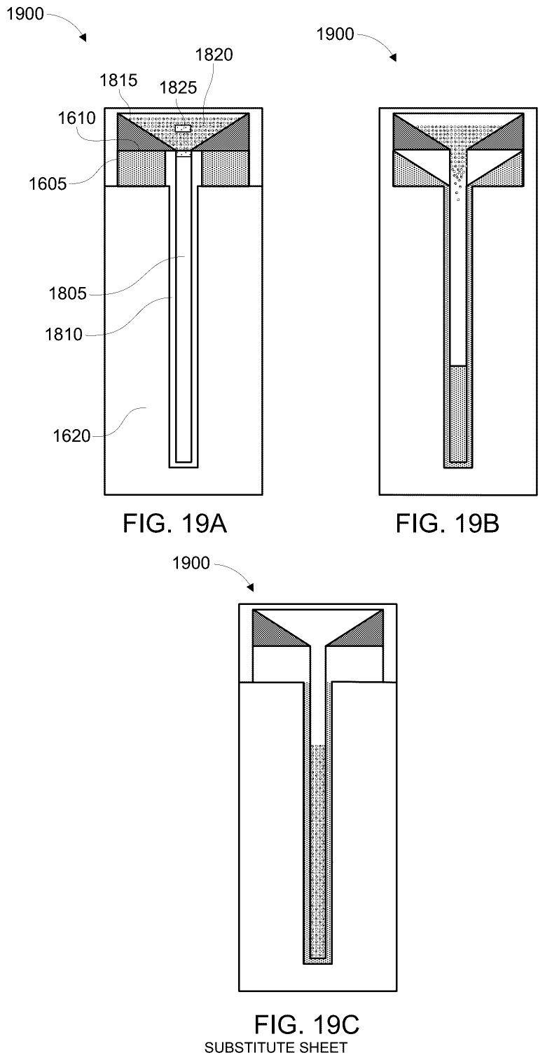

FIGS. 19A, 19B and 19C illustrate a molten salt chamber 1900 with a plurality of failsafe mechanisms. The plurality of failsafe mechanisms may be arranged next to each other, concentric relative to one another, dispersed, etc. The molten salt chamber 1900 includes the inner neutron poison channel 1805 and the outer neutron poison channel 1810. The neutron poison chamber 1610 can include a solid neutron poison 1605 may be coupled with the inner neutron poison channel 1805. A sphere neutron poison chamber 1815 comprising a plurality of shutdown spheres 1820 arranged within a funnel may be coupled with the outer neutron poison channel 1810 via a magnetic retention system 1825. As the temperature of the molten salt within the molten salt mixture 1620 increases toward or at the critical safety temperature, the neutron poison 1605 may melt and flow into the outer neutron poison channel 1810 and/or the magnetic retention system 1825 may open allowing the shutdown spheres 1820 to flow into the inner neutron poison channel 1805 as shown in FIG. 19B and FIG. 19C. In some embodiments, the neutron poison 1605 may melt and flow into the outer neutron poison channel 1810 prior to the failsafe channel 1625 releasing and allowing the shutdown spheres 1820 to flow into the inner neutron poison channel 1805. In some embodiments, the magnetic retention system 1825 may release prior to the neutron poison 1605 melting.

Some embodiments include a passive reactivity control system. A passive reactivity control system, for example, may allow for the natural thermal expansion of the molten salt mixture to control the reactivity of the system. A perforated separator 125 disposed within a molten salt chamber, for example, may allow some of the molten salt mixture to pass through one or more of a plurality of perforations (or channels) within the perforated separator 125 while allowing the moderator material to remain within the molten salt chamber below the perforated separator 125. As the molten salt mixture expands, some of the molten salt mixture will pass through the perforations in the perforated separator 125. The perforations in the perforated separator may, for example, include tubes or a mesh etc. The perforations in the perforated separator may, for example, have diameters smaller than the diameter of the perforations in the perforated separator.

In some embodiments, the molten salt reactor 100 may include a perforated separator 125 that separates the molten salt chamber 120 from the expansion volume 130. The expansion volume 130 may, for example, include or comprise an inert gas or vacuum. The perforated separator 125 may be a perforated separator. In some embodiments, the expansion volume 130 may define an expansion volume that allows the molten salt mixture to expand into the expansion volume 130. The perforated separator 125, for example, may include a plurality of perforations or channels that allow the molten salt to flow into the expansion volume 130 when the molten salt expands such as, for example, due to temperature increases. The perforated separator 125, for example, may comprise iridium.

In some embodiments, the perforated separator 125 may comprise a material that resists corrosion from molten salt and/or may comprise a material that is not intended to block or shield neutrons such as molybdenum or silicon carbide. The perforated separator may, for example, include a material that shields or absorbs neutrons such as, for example, boron, gadolinium, samarium, cadmium, boron carbide, tungsten, lead, etc., or any combination thereof. In some embodiments, the perforated separator may maintain pressure on the packed bed of moderating material.

In some embodiments, the perforated separator 125 may comprise a material that absorbs neutrons such as, for example, boron carbide, silicon carbide, samarium oxide, or gadolinium oxide.

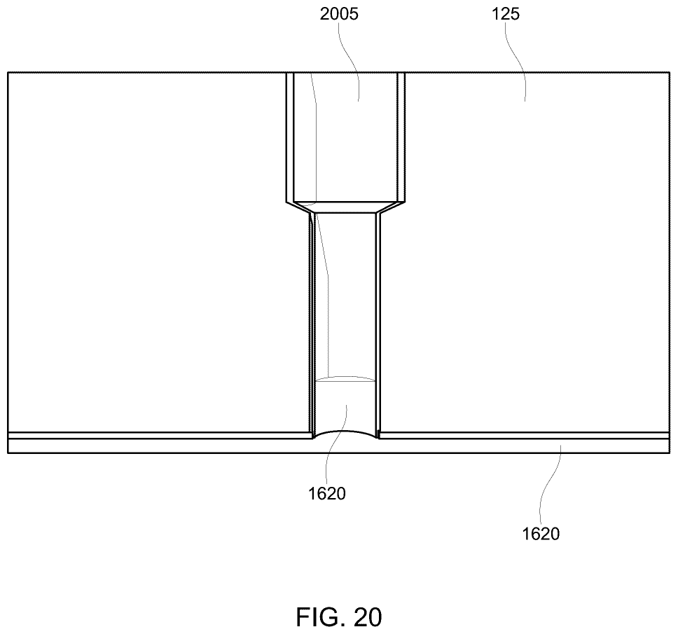

FIG. 20 is a side view of a perforation 2005 in a perforated separator 125 according to some embodiments. In this illustration, a molten salt mixture 1620 within the molten salt mixture 1620 has expanded partially into the perforation 2005.

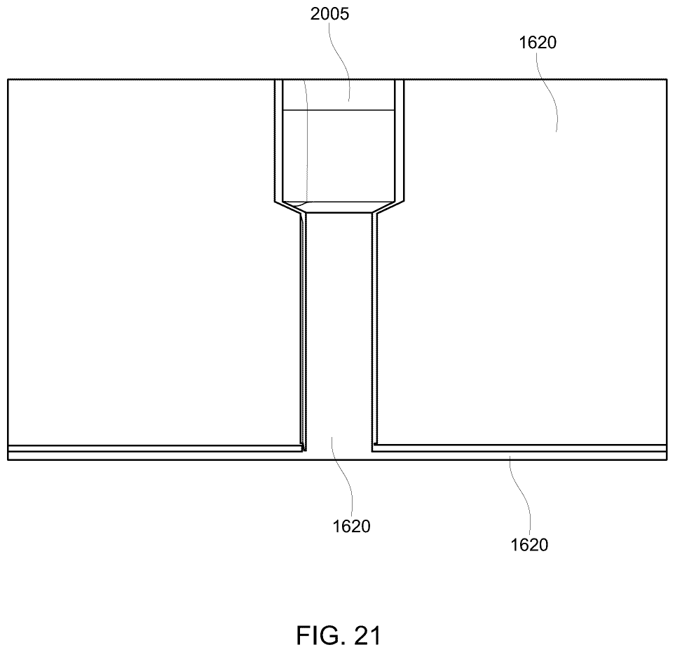

FIG. 21 is a side view of the perforation in a perforated separator 125 according to some embodiments. In this drawing, a molten salt mixture 1620 within the molten salt mixture 1620 has expanded more fully into the perforation 2005. As the molten salt expands into the perforation 2005, the molten salt cools.

In some embodiments, a molten salt reactor may include a passive reactivity control system that includes one or more holes in a reflector. These holes may allow for the molten salt mixture to expand and pass into or through these holes to reach an area above the reflector or outside the molten salt chamber. The hole and/or area may be lined with a neutron absorber (e.g. boron carbide, samarium oxide, or gadolinium oxide), which may, for example, reduce the number of fissions in the expanded salt.

In some embodiments, a molten salt mixture with moderator particles disposed in a chamber below a perforated separator may self-regulate a nuclear reaction such that the temperature of the reactor passively operates around a specific operating temperature (e.g., negative reactivity temperature feedback). As neutrons from the molten salt mixture collide with fissile material (e.g., uranium 233, uranium 235, plutonium 239, plutonium 241), a fission reaction may occur, and heat may be produced. This heat may cause the molten salt to increase in temperature, expand in volume, and decrease in density. As the molten salt expands through the perforated separator, some of the molten salt will pass through the perforations in the perforated separator leaving a higher proportion of moderator particles that will slow down the fission reaction and lower the temperature. The molten salt remaining in the molten salt reactor, for example, may not contribute to fission reactivity because the neutrons are not moderated and/or are likely to be absorbed into neutron poisons than to collide with fissile material and cause fission.

In some embodiments, a change in density of the molten salt mixture may self-regulate a nuclear reaction such that the temperature of the reactor passively operates around a specific operating temperature. As the temperature within the molten salt mixture increases, the volume increases, and the density decreases. A decrease in density may cause the neutron flux within the reactor to slow. As the neutron flux slows, the heat input within the molten salt reactor decreases because neutrons are less likely to collide with fissile material, which will cause the fission reaction to slow.

In some embodiments, the self-regulating nature of the fission reaction (e.g., the negative reactivity temperature feedback) may be enhanced by filling the reactor chamber with a molten salt mixture above the level of any moderators (e.g., packed bed of diamond particles). As the molten salt mixture expands, a larger portion of the molten salt is not surrounded by moderator.

In some embodiments, a layer of neutron reflecting material may be placed surrounding the molten salt chamber. The neutron reflecting material, for example, may include silicon carbide, diamond, beryllium oxide, graphite, etc. The neutron reflecting material, for example, may include a packed bed of neutron moderating particles, which may comprise diamond particles, powdered beryllium oxide, silicon carbide, etc.

In some embodiments, the neutron reflecting material may comprise a packed bed of diamond particles that surround the molten salt chamber and/r may act as a reflector that has a high thermal conductivity. In some embodiments, a heavy element such as, for example, lead, may be melted into the packed bed of particles. The heavy element may, for example, block gamma rays while allowing the neutron reflecting material to reflect neutrons.

In some embodiments, a molten salt reactor may include a breeding blanket. The breeding blanket may, for example, completely or partially surround the molten salt chamber. The breeding blanket may, for example, aid in the production of fissile nuclides. The breeding blanket may, for example, be disposed between the molten salt chamber and the neutron reflecting material.

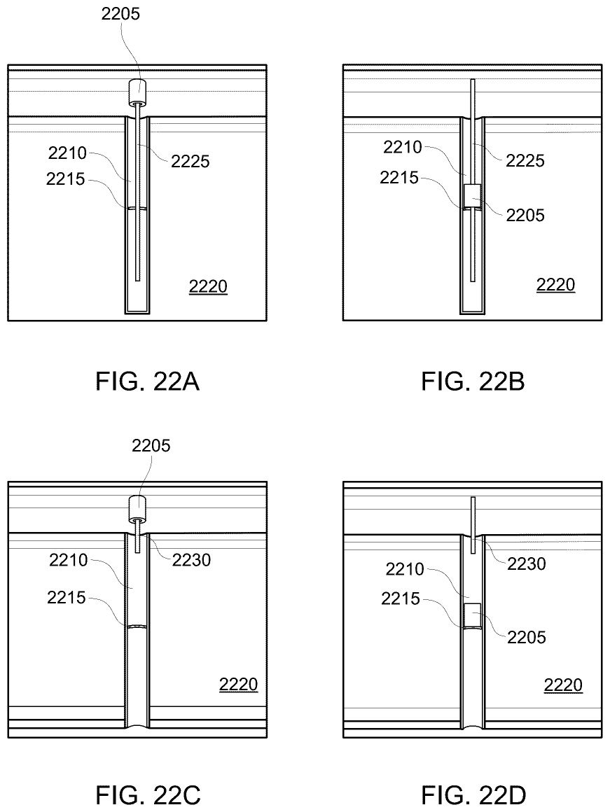

FIGS. 22A, 22B, 22C, and 22D illustrate a neutron poison failsafe 2205 disposed within a coolant channel 2210 such as, for example, one or more coolant channels 135, heat exchanger tubes 910, exterior tube 1015, etc. The neutron poison failsafe 2205 may not be affixed to the coolant channel 2210 wall and/or may be able to move within the coolant channel 2210.

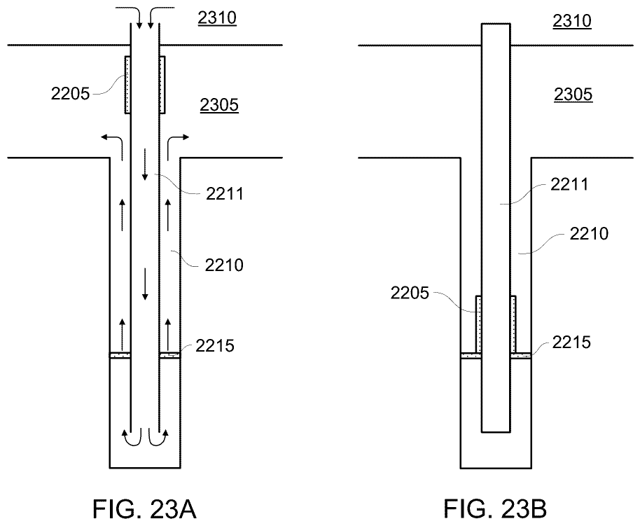

FIGS. 22B, 22D, and 23B illustrate a neutron poison failsafe 2205 when coolant is not flowing through the coolant channel 2210. When this occurs the neutron poison failsafe 2205 is located within a portion of the coolant channel 2210 at least partially surrounded by molten salt chamber 2220 and/or within a portion of the coolant channel 2210 with a high neutron flux. In this position, the neutron poison failsafe 2205 may cause a fission reaction to lose criticality and/or may lead to a shutdown. FIGS. 22A, 22C and 23A illustrate when coolant is flowing through the coolant channel 2210. When this occurs the neutron poison failsafe 2205 may be forced by the flow of coolant out of the portion of the coolant channel 2210 within the molten salt chamber. In this position, a fission reaction may reach criticality.

In some embodiments, the neutron poison failsafe 2205 may have an annular or ring shape with an inner aperture. A concentric rod 2225 may be disposed within the coolant channel 2210 and may extend within the inner aperture of the neutron poison failsafe 2205 as shown in FIGS. 22A and 22B.

In some embodiments, the neutron poison failsafe 2205 may have a through-flow configuration as shown in FIGS. 22C and 22D.

In operation, when coolant is flowing through the coolant channel 2210, the neutron poison failsafe 2205 is forced outside of the portion of the portion of the coolant channel 2210 within the molten salt chamber 2220 allowing fission reactions to occur within the molten salt chamber 2220. When coolant is no longer flowing through the coolant channel 2210, the neutron poison failsafe 2205 falls into the portion of the coolant channel 2210 within the molten salt chamber 2220 such as, for example, via gravity or an external force.

In some embodiments, the coolant channel 2210 may include one or more standoffs 2215 that position the neutron poison failsafe 2205 within the portion of the coolant channel 2210 within the molten salt chamber 2220. The one or more standoffs 2215 may include a plurality of spokes or blades that allow coolant to flow within the coolant channel 2210 but also stop the movement of the neutron poison failsafe 2205 within the coolant channel 2210.

In some embodiments, the neutron poison failsafe 2205 may comprise tungsten or any other neutron poison.

FIGS. 23A and 23B illustrate a neutron poison failsafe 2205 within a coolant channel 2210 according to some embodiments. The coolant channel 2210 includes an inner concentric coolant channel 2211. The neutron poison failsafe 2205 may have an annular or ring shape that surrounds the inner concentric coolant channel 2211 and may move within and without the coolant channel 2210 by sliding up and down along the inner concentric coolant channel 2211. The one or more standoffs 2215 may include a plurality of spokes or blades that allow coolant to flow within the coolant channel 2210 but also stop the movement of the neutron poison failsafe 2205 within the coolant channel 2210.

In some embodiments, the neutron poison failsafe 2205 may have a density that is greater than the density of the coolant.

In some embodiments, coolant pumps may flow in one direction as shown in FIG. 23A. The coolant pumps may flow in the other direction causing coolant to flow down the outer concentric coolant channel 2210 (or the coolant channel 2210) to ensure the neutron poison failsafe 2205 is moved into the position shown in FIG. 23B (or FIG. 22B or FIG. 22D).

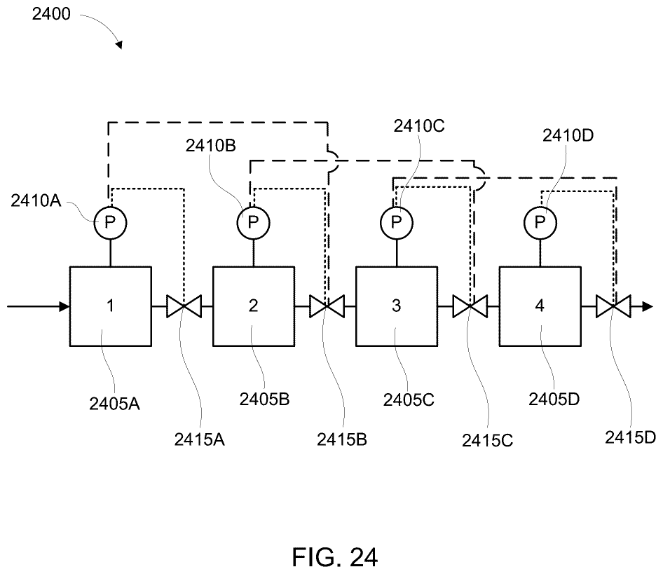

FIG. 24 illustrates an off-gas release system 2400 according to some embodiments. The off-gas release system 2400 may include a plurality of gas chambers 2405. In this example, four gas chambers 2405 are shown: gas chamber 2405A, gas chamber 2405B, gas chamber 2405C, and gas chamber 2405D. Each chamber may include a pressure sensor 2410 and/or a valve 2415. Each valve 2415 may be set to open at a specific pressure measured by the pressure sensor 2410. The valve 2415 may release gases from one chamber to the next chamber or into the atmosphere or another chamber or vessel. The valves 2415 may include mechanical valves, pneumatic valves, electrical valves, or valves that are electrically actuated via piezoelectric element, etc.

Some products from a fission reaction are radioactive gasses that decay over time. For example, xenon 135 is a common fission product with a half-life of about 9.14 hours and xenon 133 is another common fission product with a half-life of 5.25 days. Some gaseous fission products may decay to become liquid or solid at operating temperatures. For example, xenon 135 which is a gas at room temperature decays into cesium 135 which melts at ˜28.44 Celsius and boils at ˜670.8 Celsius. Thus some of the gaseous xenon 135 will decay into cesium and condense into a liquid in the off-gas release system chambers. The off-gas release system 2400 may allow for decay to occur within these chambers prior to release into the atmosphere or another chamber (or vessel).

Gases from a molten salt chamber may be released into the gas chamber 2405A. When the pressure sensor 2410A measures a pressure that is a percentage of a first pressure set point, the valve 2415B is opened to allow gas chamber 2405C and gas chamber 2405B to equilibrate. When the pressure sensor 2410A measures a pressure equal to the first pressure set point the valve 2415B is closed and the valve 2415A is opened.

Gases from the gas chamber 2405A may be released into the gas chamber 2405B. When the pressure sensor 2410B measures a pressure that is a percentage of a second pressure set point, the valve 2415C is opened to allow gas chamber 2405C and gas chamber 2405D to equilibrate. When the pressure sensor 2410B measures a pressure equal to the second pressure set point the valve 2415C is closed and the valve 2415B is opened.

Gases from the gas chamber 2405B may be released into the gas chamber 2405A. When the pressure sensor 2410C measures a pressure that is a percentage of a third pressure set point, the valve 2415D is opened to allow gas chamber 2405D and the external environment (another chamber or vessel or the atmosphere) to equilibrate. When the pressure sensor 2410C measures a pressure equal to the third pressure set point the valve 2415D is closed and the valve 2415C is opened.

Gases from the gas chamber 2405C may be released into the gas chamber 2405D. When the pressure sensor 2410D measures a pressure equal to a fourth pressure set point the valve 2415D is opened.

The various pressure set points may relate to a pressure the results in a decay of certain fission products. In some embodiments, the timing of the valves, the size and quantity of the chambers, or the pressure set points of the valves may be configured to allow radioactive fission products to decay sufficiently prior to release or storage.

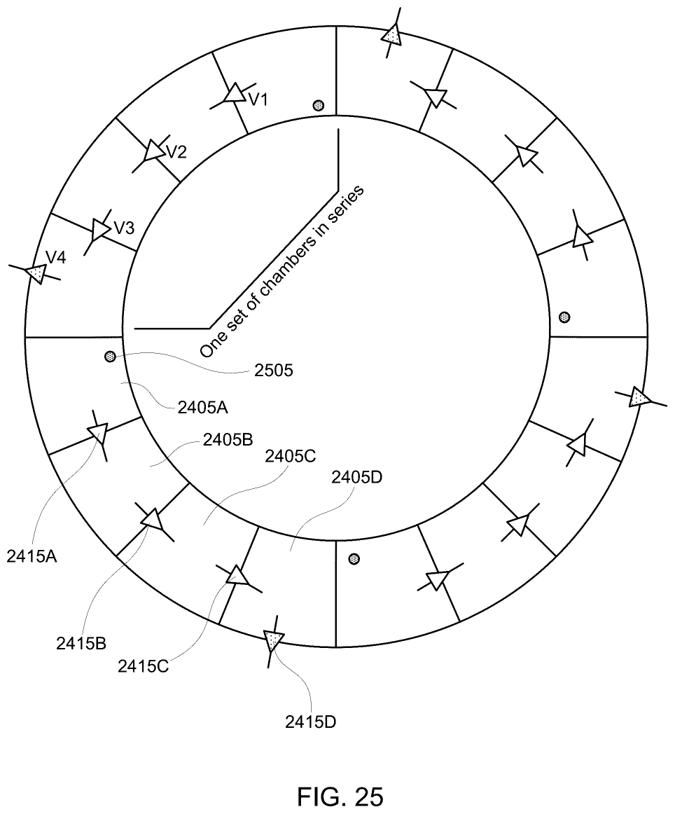

In some embodiments, the various gas chambers 2405 may be arranged in various sets and/or arranged in a concentric circle as shown in FIG. 25. In this example, four series of gas chambers are shown with each series of gas chambers including four gas chambers. Any number of gas chambers may be included in each series of gas chambers and/or any number of series of gas chambers may be used.

Gas from a molten salt chamber may be introduced into gas chamber 2405A via input 2505. The gases may then be processed through the various chambers allowing for decay of the fission products as noted in FIG. 24. In some embodiments, the series of gas chambers may allow for radioactive fission products to decayed sufficiently prior to release or storage.

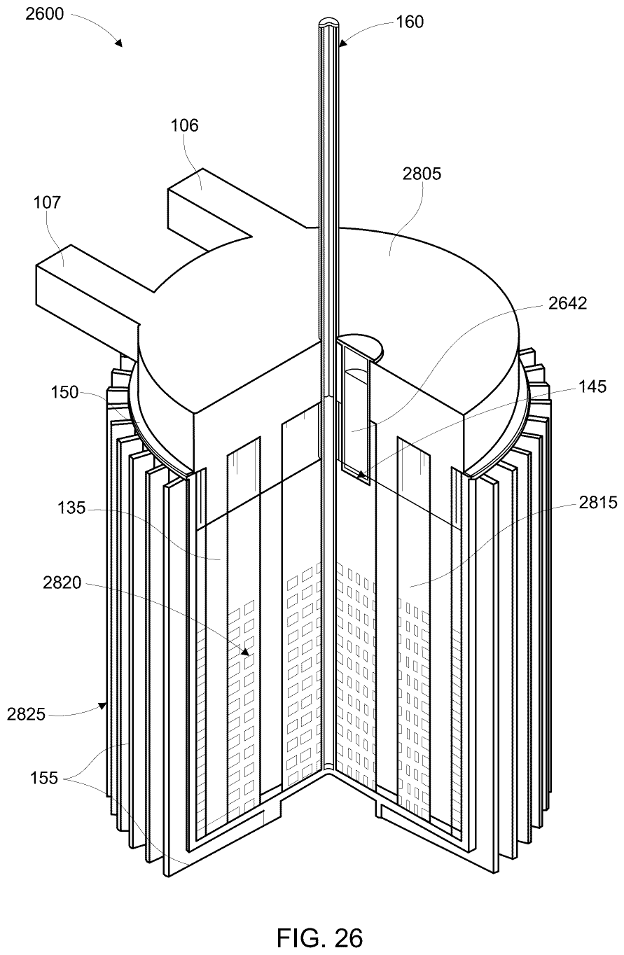

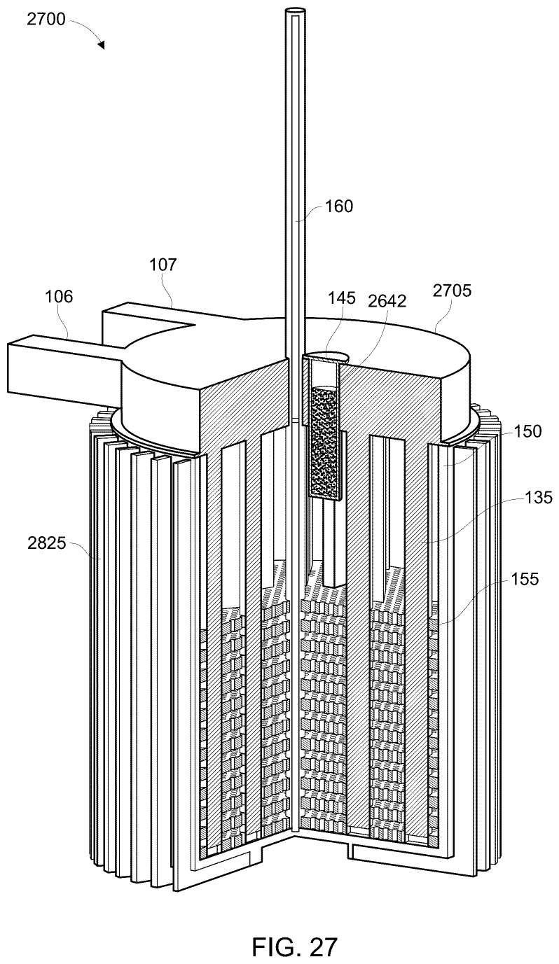

FIG. 26 and FIG. 27 are illustrations of a self-contained molten salt reactor 100 according to some embodiments. The self-contained molten salt reactor chamber 2600 can include at least a reactor, a heat exchange subsystem, and a thermal safety failsafe. The self-contained molten salt reactor chamber 2600 can include at least a reactor, a heat exchange subsystem, and a thermal safety failsafe.

In some embodiments, the reactor can include a reactor body that includes diamond coated internal wall surfaces. The reactor body can include an outer reactor body 150 and a structural matrix 2820.

The structural matrix 2820, for example, may include a plurality of molten salt channels where the molten salt is disposed. The structural matrix 2820, for example, may include a plurality of a plurality of heat exchanger channels where coolant channels 2835 may extend.

The structural matrix 2820, for example, may include a plurality of reactor plates. The plurality of reactor plates 155 enclosed within the reactor body 150 and stacked one upon another. In some embodiments, the inner layer of the reactor body 150 can be plated with a diamond surface. In some embodiments, the reactor plates 155 can be coated with a diamond surface. In some embodiments, the reactor plates 155 may only be stacked about half, about two-thirds, or about three-quarters of the height of the reactor body 150. In some embodiments, there may be a space 2815 that does not include any reactor plates 155.

In some embodiments, the reactor body 150 may include a cobalt and/or iron shell with boron inside or alloy or composite.

In some embodiments, the reactor body 150 may include a reflector. The reflector may be formed as part of the reactor body 150 or surrounding the reactor body 150 or internal to the reactor body 150. In some embodiments, the reflector may reflect neutrons back into the reactor and allow gamma arrays to pass through the reflector. In some embodiments, the reflector may comprise a diamond material and/or a lead material.

In some embodiments, the reflector may comprise diamond and/or lead material. The diamond, for example, may block neutrons and the lead may allow the gamma rays to pass through the material. In some embodiments, a diamond and lead material may be created by melting lead into diamond particles.

In some embodiments, a reflector may be used as a failsafe or shutdown mechanism. In some embodiments, the reflector may maintain reaction criticality. If the reflector is removed, for example, criticality will end, and so will the fission reaction. In some embodiments, the reflector may include a lead diamond material.

The reflector may be placed, for example, around the reactor as a sleeve that is automatically removed when the reactor reaches a certain temperature. As another example, the reflector may include hinges that are automatically opened (or closed) to move the reflector when the reactor reaches a certain temperature. In some embodiments, a magnet (or electromagnet) may have a curie temperature. At the curie temperature the magnetic field produced by the magnet is weakened sufficiently to no longer hold the reflector in place. The magnet may be selected to ensure the curie temperature is less than the critical safety temperature of the molten salt mixture and/or the molten salt chamber. If the temperature is below the curie temperature (and/or long as a charge is applied to an electromagnet) the magnet may hold the reflector in place. When magnetism ceases, such as, for example, when the reactor is out of control, a switch is flipped, the curie temperature is reached (e.g., or within 5% or 10% of the curie temperature), a sensor senses an anomaly, or a sensor senses an event, then the electricity to the magnet may be removed and the reflector may drop under the force of gravity or hinges may engage under force of a spring and the reflector rotated or moved away from the reactor. The magnet may be selected with a curie temperature, for example, that is less than the critical safety temperature of the molten salt mixture and/or the molten salt chamber and/or may depend on the location of the magnet relative to the molten salt chamber, the heat diffusion properties of the chamber and other components, etc.

The magnet may have a curie temperature and/or configuration relative to the critical safety temperature such that the magnet may release at or near the critical safety temperature. In some embodiments, the failsafe may include a magnet (or electromagnet) that holds control rods or a neutron poison. The magnet may comprise a material, for example, that may have a curie temperature that is at or below the critical safety temperature of the molten salt mixture and/or the molten salt chamber. When the critical safety temperature is reached, the magnetic field is weakened, and the magnet may release one or more control rods, reflectors, etc. that may control or limit the reaction within the reactor such as, for example, if there is a coolant problem. The magnet may be selected with a curie temperature, for example, that is less than the critical safety temperature of the molten salt mixture and/or the molten salt chamber and/or may depend on the location of the magnet relative to the molten salt chamber, the heat diffusion properties of the chamber and other components, etc.

In some embodiments, a magnet (or electromagnet) may comprise Neodymium, Cobalt samarium, etc. Neodymium magnets, for example, can operate at temperatures up to about 230° C. and have a curie temperature of about 350° C. Cobalt samarium magnets, for example, can work in temperatures as high as about 550° C. with curie temperatures close to about 800° C.

In some embodiments, the reactor plates 155 (or radial thermally conductive plates) may allow for decay heat to be removed without active pumping or convection.

A diamond surface in the reactor, for example, can thermalize neutrons or increase thermal conductivity. On non-diamond surfaces ions can change electronegativity state from one to another by trading electrons. On a diamond surface, for example, there may be no electrical conductivity which can help avoid this electronegativity state change.

A diamond surface, for example, may comprise a diamond powder. As another example, the surfaces can be coated with diamond that are deposited using a chemical vapor deposition technique. As another example, the internal surfaces can be coated with diamond that include a monocrystal layer that is grown on the internal surface. As yet another example, the internal surface can include diamond embedded, forged, or cast into a metal surface such as, for example, a molybdenum metal surface (e.g., 75% diamond, 25% metal).

In some embodiments, the outer reactor body 150 may include a plurality of fins 2825. The fins 2825, for example, may passively exhaust decay heat when the reactor is off.

In some embodiments, the plurality of reactor plates 155 may be stacked on upon another within the outer reactor body 150. In some embodiments, a plurality of spacers may be disposed between the plurality of reactor plates 155. The molten salt eutectic may be disposed within the reactor between the reactor plates 155 and within the molten salt channels 405.

The molten salt eutectic (or molten salt mixture) within the reactor may expand above a first temperature (e.g., 850° C.) causing the molten salt eutectic to expand into the region above the reactor plates 155, which may passively reduce the reaction rate. The molten salt eutectic (or molten salt mixture) within the reactor may contract above a second temperature (e.g., 750° C.) causing the molten salt eutectic to contract into the reactor plates 155, which may passively increase the reaction rate. This expansion and contraction may passively control the fission reaction with the molten salt eutectic.

FIG. 25 29 and FIG. 2630 show examples of a single reactor plate 155. In some embodiments, a reactor plate 155 may comprise molybdenum, or a molybdenum alloy such as, for example, an alloy of molybdenum, titanium, and zirconium (e.g., TZM). Each reactor plate 155 may comprise a disk shape having a diameter and a thickness. Each plate 155, for example, may include a plurality of molten salt channels 405, a shutdown rod channel 410, or a plurality of heat exchanger channels 415. The diamond coating may coat the inner surfaces of the plurality of the molten salt channels 405, the shutdown rod channel 410, or the plurality of heat exchanger channels 415.

Each reactor plate 155, for example, may comprise, for example, monocrystalline, or polycrystalline silicon carbide.

In some embodiments, the molten salt channels 405 may include circular or rectangular shaped apertures cut within each reactor plate 155. Each reactor plate 155, for example, may include 20-850 molten salt channels 405. The number, size, and density of the molten salt channels 405 can affect the speed or heat of the fission reaction within the molten salt reactor chamber.

In some embodiments, the plurality of heat exchanger channels 415 may include circular or rectangular shaped apertures cut within each reactor plate 155. The plurality of heat exchanger channels 415 may be sized and shaped to correspond with the coolant channels 135. Each reactor plate 155, for example, may include 5-25 heat exchanger channels 415.

In some embodiments, the reactor plates 155 may comprise a molybdenum shell with powdered diamond or aluminum inside. The diamond, for example, may act as a neutron moderator. The aluminum, for example, may become molten at temperature and facilitates thermal conductivity.

In some embodiments, the reactor plates 155 may comprise solid diamond, which may facilitate thermal conduction or thermalizing neutrons.

In some embodiments, the reactor plates 155 may comprise molybdenum or TZM holding/encapsulating diamond (e.g., powder, laser sintered, grown, polycrystalline, monocrystalline, cvd, bulk diamond of various sizes, etc.) with space (slots or holes) arranged to allow for heat removal via an additional thermal path (e.g., a perpendicular path). In some embodiments, the reactor plates 155 may be spaced such that they are close enough to facilitate conductive heat removal and allowing for neutrons to be thermalized. In some embodiments, passages between reactor plates 155 allowing molten salt and fission products to diffuse and equilibrate.

In some embodiments, the reactor plates 155 may be stacked together and/or made of a molybdenum and/or a diamond matrix.

In some embodiments, the reactor plates 155 may be stacked together and/or made of a TZM and/or a diamond matrix.

In some embodiments, stacked reactor plates 155 may allow for heat removal via conduction or radiation.

In some embodiments, the shutdown rod channel 410 may be an aperture disposed within the center of each reactor plate. The shutdown rod channel 410 may be sized and configured to allow the shutdown rod 160 to slide within the shutdown rod channel 410 or a plurality of spheres to flow through the shutdown rod channel 410 into the reactor. The shutdown rod or the spheres, for example, may comprise boron, boron carbide, or any other neutron dampening material.

In some embodiments, the molten salt with a fissile material may be disposed between the molten salt channels 405 within the reactor body 150.

In some embodiments, the molten salt reactor chamber 2600 may include a passive expansion chamber that does not include a moderating material. As the molten salt heats up, it may expand causing molten salt to flow into the expansion chamber. Because of the lack of moderating material in the expansion chamber, the neutron flux will be faster causing fewer total fission reactions to occur. The fewer reactions will cause the molten salt will cool and compress. The molten salt within the expansion chamber will flow back into the molten salt reactor chamber.

In some embodiments, when the molten salt eutectic (or molten salt mixture) expands within the molten salt chamber such as, for example, as a result to increase temperatures, less fissile material may be subjected to thermal flux. For example, the molten salt chamber may include an expansion chamber that does not include any moderating material, which may increase the neutron flux causing fewer total fission reactions to occur.

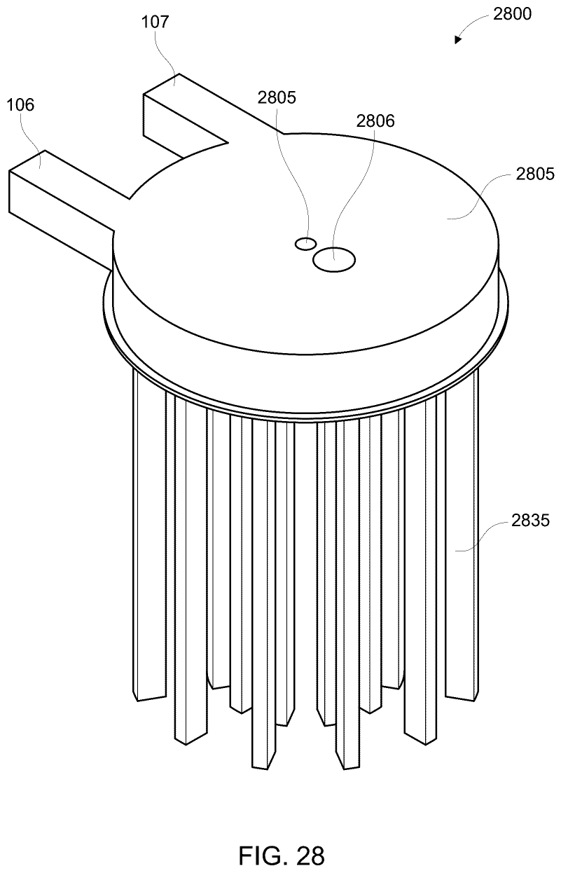

FIG. 28 is a diagram of a heat exchanger 2800 according to some embodiments. The heat exchanger 2800 may include a heat exchanger manifold 2805, a coolant inlet 106, a coolant outlet 107, and/or a plurality of coolant channels 2835 that extend downwardly from the exchanger manifold 2805. In some embodiments, clean molten salt (e.g., without any fissile products) can flow into the heat exchanger manifold 2805 from the coolant inlet 106, and exit the coolant outlet 107. The plurality of coolant channels 2835 may include printed circuit board heat exchangers.

The plurality of coolant channels 2835 may extract heat from the molten salts with the fissile material disposed throughout the reactor.

In some embodiments, the molten salt reactor chamber 2600 may include a shutdown rod 160. The shutdown rod 160, for example, may comprise a cylindrically shaped rod comprising boron, boron carbide, or any other neutron dampening material. The shutdown rod 160, for example, may be actuated into and out of the reactor using a magnetic (or electromagnetic) actuator. The shutdown rod 160, for example, slide into the reactor through a rod aperture 2805 within the exchanger manifold 2805 or through the plurality of reactor plates 155. The shutdown rod 160, for example, can be inserted into the reactor to stop the reaction and removed to start the reaction. The boron (or other material) within the rod can absorb neutrons, which may effectively stop or sufficiently slow the fissile reaction.

In some embodiments, the shutdown rod 160 may be replaced with a vessel containing a plurality of spheres comprising boron, boron carbide, or any other neutron dampening material. The spheres may be delivered into or out of the reactor as needed to control the reactivity of the molten salt reactor chamber.

In some embodiments, the thermal safety failsafe 2642 may include a material that melts at a temperature that is at or above the critical safety temperature (e.g., about 1,000° C.-1,300° C.; e.g., 1,200° C.) of the molten salts in the reactor. When the safety failsafe 2642 melts, a neutron poison (e.g., samarium-149, xenon-135, krypton-83, molybdenum-95, neodymium-143, promethium-147, gadolinium, or boron-10) can be released into the reactor through failsafe aperture 2806 slowing or stopping the fission reaction in the molten salt reactor chamber. In some embodiments, a plurality of thermal safety failsafes may be included. In some embodiments, the thermal safety failsafe 2642 may include a metal such as, for example, silver, gold, copper, brass, nickel, etc. In some embodiments, the thermal safety failsafe 2642 may include a salt such as, for example, or sodium fluoride, magnesium fluoride, or potassium fluoride.

In some embodiments, the thermal safety failsafe 2642 may include a cylinder with a solder cap and a neutron poison. The solder cap may have a melting point that is at or above the critical safety temperature of the molten salts in the reactor. The solder cap may, for example, be positioned at or near the bottom of the thermal safety failsafe. When the solder cap melts, for example, the neutron poison may be released into the reactor. The thermal safety failsafe 2642 may be placed within about three, six or twelve inches from the reactor and the melting temperature of the solder cap may be adjusted based on the distance from the reactor.

In some embodiments, the thermal safety failsafe 2642 may be connected with a vessel filled with spheres such as, for example, spheres comprising boron, boron carbide, or any other neutron dampening material. When the thermal safety failsafe 2642 melts the spheres may flow from the vessel into the molten salt reactor chamber.

In some embodiments, the neutron poison 145 and/or the shutdown rod 160 may comprise boron balls. Boron balls, for example, may include boron and/or a magnetic (or ferromagnetic) metal such as, for example, iron or cobalt. The neutron poison (and/or the shutdown rod 160) may be shaped, for example, into balls so they can be place into a helical chamber for compact storage.

The neutron poison may be magnetic so it can be suspended magnetically by an active magnet (or electromagnet). In some embodiments, the magnetic can be turned off to drop the balls into the reactor the shut down the reactor. In some embodiments, the neutron poison can be composed and weighted such that at a failsafe temperature magnetism strength diminishes and balls drop.

In some embodiments, the neutron poison 145 and/or the shutdown rod 160 may include a short rod (e.g., at least half the height of the molten salt reactor chamber 2600).

In some embodiments, the thermal safety failsafe 2642 and/or the neutron poison 145 may comprise a plurality of thermal safety failsafe 2642 and/or neutron poisons 145.

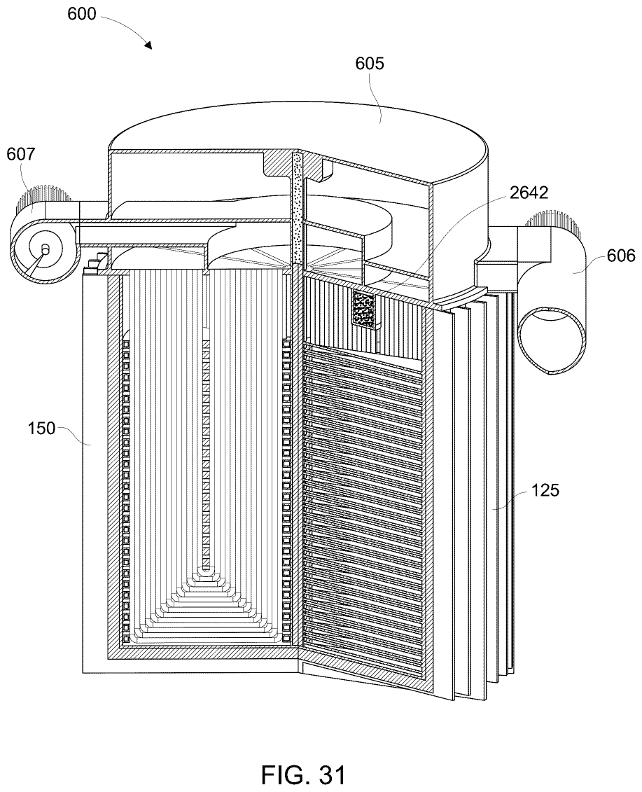

FIG. 31 is a diagram of a molten salt reactor 2700 according to some embodiments. In this example the molten salt reactor includes a manifold 2705 with a coolant inlet 106 and a coolant outlet 107.

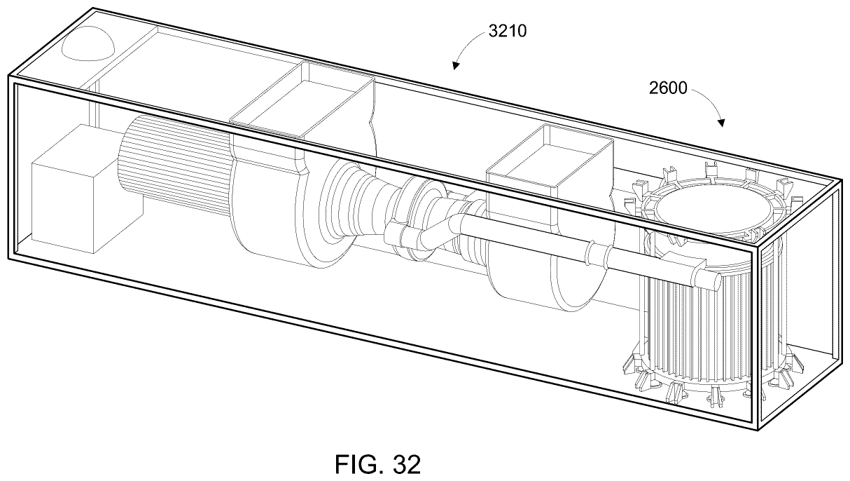

FIG. 32 is a perspective view and a perspective view of a diagram of a molten salt reactor chamber 3200 coupled with a turbine 3210 according to some embodiments.

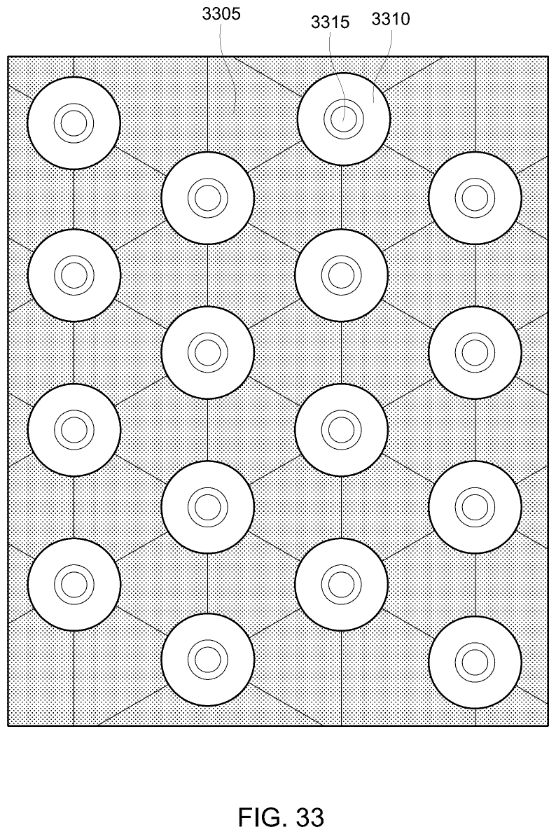

FIG. 33 illustrates a matrix of molten salt fuel vessels 3310 and diamond particle prisms 3305 according to some embodiments. The matrix of molten salt fuel vessels 3310 may be disposed within a molten salt reactor. A molten salt fuel vessel 3310 may include any type of molten salt with fissile material such as, for example, as described in this document. In some embodiments, the molten salt fuel vessel 3310 may include high assay low enriched uranium (HALEU) or low enriched uranium (LEU).

A coolant vessel 3315 may be disposed within the molten salt fuel vessel 3310. The coolant vessel 3315 and/or the molten salt fuel vessel 3310 may be tubular and/or comprise a pipe. The coolant vessel 3315 and/or the molten salt fuel vessel 3310 may comprise molybdenum or TZM.

The diamond particle prisms 3305 may include a plurality of prism, rectangle, square or polygonal shaped spaces or structures that include diamond particle. These prisms with diamond particle may act as a neutron moderator, which may help the core reach criticality.

Various thermal shutdown mechanisms or thermal failsafe mechanisms are disclosed. A thermal shutdown mechanism or a thermal failsafe mechanism may be associated with and configured for a specific critical safety temperature. This temperature, for example, may not be the same for each mechanism since certain failure modes may or may not be preferable to other failure modes. In addition, the position of the mechanism and its associated heat dissipation, for example, may affect the associated critical safety temperature. Each thermal failsafe mechanism or thermal shutdown mechanism may not to actuate until it reaches a specific critical safety temperature (or within 5% or 10% of the designed critical safety temperature) associated with the thermal failsafe mechanism or thermal shutdown mechanism. At the point of reaching its specific critical safety temperature it is designed to actuate within a small window of time and temperature.

Each thermal shutdown mechanism and thermal failsafe mechanism may have a different mode of actuating and thus requires individual configuration. Each may have a different window of actuation time and temperature. Failsafe mechanisms and shutdown mechanisms that actuate based on magnetism actuate when the strength of the magnet weakens with increasing temperatures to the point beyond its ability to retain the mechanism or neutron poison. This temperature point is configured to occur at or very near it's critical safety temperature. Failsafe and shutdown mechanisms that actuate based on melting/softening actuate when the strength of the actuation material weakens or melts with increasing temperatures to the point beyond its ability to retain the mechanism or neutron poison. This temperature point may be configured to occur at or very near a specific critical safety temperature.

Unless otherwise specified, the term “substantially” means within 5% or 10% of the value referred to or within manufacturing tolerances. Unless otherwise specified, the term “about” means within 5% or 10% of the value referred to or within manufacturing tolerances.

The conjunction “or” is inclusive.

Numerous specific details are set forth herein to provide a thorough understanding of the claimed subject matter. However, those skilled in the art will understand that the claimed subject matter may be practiced without these specific details. In other instances, methods, apparatuses or systems that would be known by one of ordinary skill have not been described in detail so as not to obscure claimed subject matter.

Some portions are presented in terms of algorithms or symbolic representations of operations on data bits or binary digital signals stored within a computing system memory, such as a computer memory. These algorithmic descriptions or representations are examples of techniques used by those of ordinary skill in the data processing arts to convey the substance of their work to others skilled in the art. An algorithm is a self-consistent sequence of operations or similar processing leading to a desired result. In this context, operations or processing involves physical manipulation of physical quantities. Typically, although not necessarily, such quantities may take the form of electrical or magnetic signals capable of being stored, transferred, combined, compared or otherwise manipulated. It has proven convenient at times, principally for reasons of common usage, to refer to such signals as bits, data, values, elements, symbols, characters, terms, numbers, numerals or the like. It should be understood, however, that all of these and similar terms are to be associated with appropriate physical quantities and are merely convenient labels. Unless specifically stated otherwise, it is appreciated that throughout this specification discussions utilizing terms such as “processing,” “computing,” “calculating,” “determining,” and “identifying” or the like refer to actions or processes of a computing device, such as one or more computers or a similar electronic computing device or devices, that manipulate or transform data represented as physical electronic or magnetic quantities within memories, registers, or other information storage devices, transmission devices, or display devices of the computing platform.

The system or systems discussed herein are not limited to any particular hardware architecture or configuration. A computing device can include any suitable arrangement of components that provides a result conditioned on one or more inputs. Suitable computing devices include multipurpose microprocessor-based computer systems accessing stored software that programs or configures the computing system from a general-purpose computing apparatus to a specialized computing apparatus implementing one or more embodiments of the present subject matter. Any suitable programming, scripting, or other type of language or combinations of languages may be used to implement the teachings contained herein in software to be used in programming or configuring a computing device.

Embodiments of the methods disclosed herein may be performed in the operation of such computing devices. The order of the blocks presented in the examples above can be varied—for example, blocks can be re-ordered, combined, and/or broken into sub-blocks. Certain blocks or processes can be performed in parallel.

The use of “adapted to” or “configured to” herein is meant as open and inclusive language that does not foreclose devices adapted to or configured to perform additional tasks or steps.

Additionally, the use of “based on” is meant to be open and inclusive, in that a process, step, calculation, or other action “based on” one or more recited conditions or values may, in practice, be based on additional conditions or values beyond those recited. Headings, lists, and numbering included herein are for ease of explanation only and are not meant to be limiting.

While the present subject matter has been described in detail with respect to specific embodiments thereof, it will be appreciated that those skilled in the art, upon attaining an understanding of the foregoing, may readily produce alterations to, variations of, and equivalents to such embodiments.

Accordingly, it should be understood that the present disclosure has been presented for purposes of example rather than limitation, and does not preclude inclusion of such modifications, variations and/or additions to the present subject matter as would be readily apparent to one of ordinary skill in the art.

1-147. (canceled)

148. A molten salt reactor comprising:
a molten salt chamber;
a molten salt mixture disposed within the molten salt chamber, the molten salt mixture comprising fluoride salts;
a heat exchange system disposed at least partially within the molten salt chamber; and
a thermally activated failsafe mechanism coupled with the molten salt chamber, the thermally activated failsafe mechanism passively inhibits fission reactions within the molten salt mixture by releasing a neutron poison into the molten salt chamber.

149. The molten salt reactor according to claim 148, further comprising a shutdown mechanism coupled with the molten salt chamber, the shutdown mechanism comprising a material that when actuated fission reactions within the molten salt mixture will be inhibited.

150. The molten salt reactor according to claim 149, wherein the shutdown mechanism comprises one or more shutdown rods that is actuated to inhibit or disinhibit fission reactions within the molten salt.

151. The molten salt reactor according to claim 150, wherein the shutdown mechanism comprises a magnet coupled with a shutdown rod, the magnet holds the shutdown rod in a position where the shutdown rod does not inhibit fission reactions within the molten salt, the magnet having a release temperature below the critical safety temperature of the molten salt mixture such that when the temperature of the magnet is at or near the critical safety temperature, the magnetic field is weakened sufficiently to allow the shutdown rod to move to inhibit fission reactions within the molten salt.

152. The molten salt reactor according to claim 150, wherein the one or more shutdown rod channels comprises silicon carbide and/or molybdenum.

153. The molten salt reactor according to claim 150, wherein the one or more shutdown rods comprise one or more of boron, samarium, cadmium, boron carbide, tungsten carbide, silver, tungsten, and/or gadolinium.

154. The molten salt reactor according to claim 148, wherein the thermally activated failsafe comprises a neutron poison chamber coupled with the molten salt chamber, and the neutron poison is disposed within the neutron poison chamber, the thermally activated failsafe comprises a thermally activated door disposed between the molten salt chamber and the neutron poison chamber such that the thermally activated door is closed when the temperature is below a critical safety temperature and opened when the temperature is above the critical safety temperature.

155. The molten salt reactor according to claim 154, wherein the critical safety temperature is above about 1,000 C and below about 1,300 C.

156. The molten salt reactor according to claim 148, wherein the neutron poison has a melting point about at the critical safety temperature and disposed relative to the molten salt chamber such that when the critical safety temperature is exceeded, the neutron poison melts and flows into the molten salt chamber.

157. The molten salt reactor according to claim 148, wherein the molten salt chamber includes a neutron moderator.

158. A molten salt reactor comprising:
a molten salt chamber;
a molten salt mixture disposed within the molten salt chamber, the molten salt comprising a fluoride salt;
a heat exchange system at least partially disposed within the molten salt chamber; and
a shutdown mechanism coupled with the molten salt chamber, the shutdown mechanism comprising a material that when actuated fission reactions within the molten salt mixture will be inhibited.

159. The molten salt reactor according to claim 158, wherein the shutdown mechanism comprises one or more shutdown rods that is actuated to inhibit fission reactions within the molten salt.

160. The molten salt reactor according to claim 159, wherein the shutdown mechanism comprises a magnet coupled with a shutdown rod, the magnet holds the shutdown rod in a position where the shutdown rod in a position that does not inhibit fission reactions within molten salt, the magnet having a release temperature below the critical safety temperature of the molten salt mixture such that when the temperature of the magnet is at or near the critical safety temperature, the magnetic field is weakened sufficiently to allow the shutdown rod to move to inhibit fission reactions within the molten salt.

161. The molten salt reactor according to claim 159, wherein the one or more shutdown rod channels comprises silicon carbide and/or molybdenum.

162. The molten salt reactor according to claim 159, wherein the one or more shutdown rods comprise one or more of boron, samarium, cadmium, boron carbide, tungsten carbide, silver, tungsten, and/or gadolinium.

163. A molten salt reactor comprising:
a molten salt chamber;
a molten salt mixture disposed within the molten salt chamber, the molten salt comprising a fluoride salt;
a shutdown rod comprising a neutron dampening material; and
a magnet coupled with the shutdown rod, the magnet holding the shutdown rod in a position where the shutdown rod does not inhibit fission reactions within the molten salt molten salt chamber, the magnet having a release temperature that is at or near the critical safety temperature of the molten salt mixture such that when the temperature of the magnet is at or near the critical safety temperature, the magnetic field is weakened sufficiently to allow the shutdown rod to move to inhibit fission reactions within the molten salt.

164. The molten salt reactor according to claim 163, further comprising a heat exchanger subsystem integrated with the molten salt chamber.

165. The molten salt reactor according to claim 163, wherein the shutdown rod comprises boron, boron carbide, samarium or cadmium.

166. The molten salt reactor according to claim 163, wherein the molten salt chamber includes a neutron moderator.
